(19) United States
(12) Patent Application Publication
(10) Pub. No.: US 2016/0180397 A1
(43) Pub. Date: Jun. 23, 2016

(54) DISTRIBUTION APPARATUS, DISTRIBUTION METHOD, TERMINAL DEVICE, SELECTION METHOD, AND NON-TRANSITORY COMPUTER READABLE STORAGE MEDIUM

(71) Applicant: YAHOO JAPAN CORPORATION, Tokyo (JP)

(72) Inventors: Yuki TAKI, Tokyo (JP); Yosuke ARAI, Tokyo (JP); Naoki IKEDA, Tokyo (JP); Soichi TATSUMI, Tokyo (JP); Naoto YAMAGUCHI, Tokyo (JP)

(73) Assignee: YAHOO JAPAN CORPORATION, Tokyo (JP)

(21) Appl. No.: 14/964,966

(22) Filed: Dec. 10, 2015

(30) Foreign Application Priority Data
Dec. 19, 2014 (JP) 2014-257844

(51) Int. Cl. G06Q 30/02

(52) U.S. Cl. CPC G06Q 30/0267; G06Q 30/0255

(57) ABSTRACT

A distribution apparatus according to an embodiment includes an accepting unit and a distributing unit. The accepting unit accepts an advertisement request from an application that operates can the terminal device. When the accepting unit accepts the advertisement request, the distributing unit distributes display candidate advertisements as candidates to be displayed by the terminal device to a terminal device that selects a display target advertisement based on the information on the installed applications from among the display candidate advertisements.

### CROSS-REFERENCE TO RELATED APPLICATION(S)

The present application claims priority to and incorporates by reference the entire contents of Japanese Patent Application No. 2014-257844 filed in Japan on Dec. 19, 2014.

### BACKGROUND OF THE INVENTION

1. Field of the Invention

The present invention relates to a distribution apparatus, a distribution method, a terminal device, a selection method, and a non-transitory computer readable storage medium.

2. Description of the Related Art

In recent years, smart devices, such as smartphones and tablet terminals, are in widespread use. Users who use the smart devices are increasingly acquiring information by using applications installed in the smart devices, instead of acquiring information by using web browsers. Therefore, a technology related to distribution of advertisements using information on applications instead of cookies has been proposed.

However, in the conventional technology as described above, it is not always possible to improve advertising effects. For example, even when a site that has contributed to installation or the like of an application is specified based on information on the application, it may be difficult to improve an advertising effect.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a distribution process according to an embodiment;

FIG. 2 is a diagram illustrating a configuration example of a distribution apparatus according to the embodiment;

FIG. 3 is a diagram illustrating an example of an advertisement information storage unit according to the embodiment;

FIG. 4 is a diagram illustrating an example of a user application information storage unit according to the embodiment;

FIG. 5 is a diagram illustrating an example of extraction of display candidate advertisements according to the embodiment;

FIG. 6 is a diagram illustrating a configuration example of a terminal device according to the embodiment;

FIG. 7 is a diagram illustrating a specific example of confirmation of installation of an application according to the embodiment;

FIG. 8 is a sequence diagram illustrating the flow of the distribution process according to the embodiment;

FIG. 9 is a diagram illustrating an example of update of user application information according to the embodiment;

FIG. 10 is a diagram illustrating an example of extraction of updated display candidate advertisements according to the embodiment;

FIG. 11 is a diagram illustrating an example of extraction of display candidate advertisements according to a modification;

FIG. 12 is a diagram illustrating an example of extraction of display candidate advertisements according to a modification;

FIG. 13 is a diagram illustrating an example of an advertisement information storage unit according to a modification;

FIG. 14 is a diagram illustrating an example of extraction of display candidate advertisements according to the modification;

FIG. 15 is a diagram illustrating an example of an attribute information storage unit according to a modification;

FIG. 16 is a diagram illustrating an example of extraction of display candidate advertisements according to the modification;

FIG. 17 is a diagram illustrating an example of an advertisement information storage unit according to a modification;

FIG. 18 is a diagram illustrating an example of extraction of display candidate advertisements according to the modification;

FIG. 19 is a diagram illustrating an example of a selection process performed by a terminal device according to a modification; and

FIG. 20 is a diagram illustrating an example of a hardware configuration of a computer that implements functions of the distribution apparatus.

### DETAILED DESCRIPTION OF THE PREFERRED EMBODIMENTS

Hereinafter, modes (hereinafter, referred to as “embodiments”) for carrying out a distribution apparatus, a distribution method, a distribution program, and a terminal device according to the present invention will be described in detail with reference to drawings. The distribution apparatus, the distribution method, the distribution program, and the terminal device of the present invention are not limited by the embodiments. In each of the embodiments below, the same components will be denoted by the same reference numerals and symbols, and the same explanation will be omitted.

### Embodiment

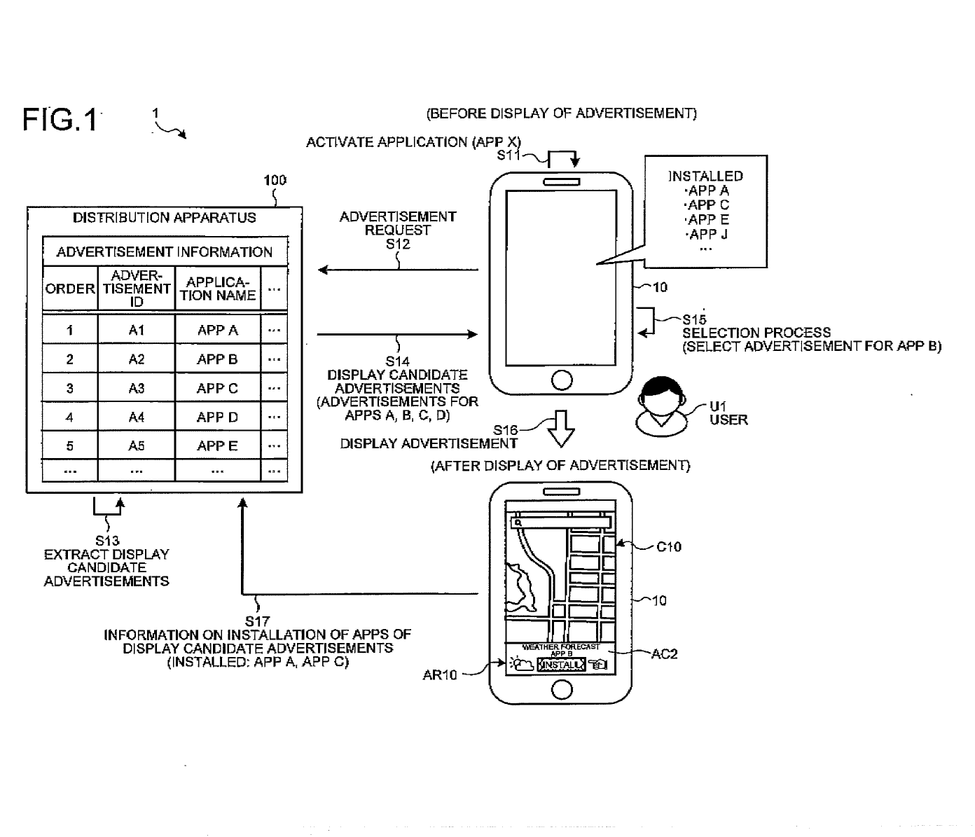

1. Distribution Process An example of a distribution process according to an embodiment will be described below with reference to FIG. 1. FIG. 1 is a diagram illustrating an example of the distribution process according to the embodiment. A distribution apparatus 100 illustrated in FIG. 1 provides a terminal device 10, which selects a display target advertisement based on information on an application installed in the terminal device 10 (hereinafter, the information may be referred to as “user application information”) from among a plurality of advertisements as candidates to be displayed on the terminal device 10 (hereinafter, the advertisements may be referred to as “display candidate advertisements”), with a distribution service to distribute the display candidate advertisements. In the example illustrated in FIG. 1, a user with a user ID of “U1” is described as a user.

As illustrated in FIG. 1, a distribution system 1 includes the terminal device 10 and the distribution apparatus 100. The terminal device 10 and the distribution apparatus 100 are communicably connected to each other by wire or wireless via a predetermined communication network (not illustrated). The distribution system 1 illustrated in FIG. 1 may include a plurality of the terminal devices 10 and a plurality of the distribution apparatuses 100.

The terminal device 10 is an information processing apparatus used by the user. The terminal device 10 activates an application (hereinafter, may be referred to as an “app”) installed in the terminal device 10, in accordance with operation by the user. Furthermore, the terminal device 10 selects an advertisement as a display target based on the user application information from among the display candidate advertisements distributed by the distribution apparatus 100. Hereinafter, the terminal device 10 may be described as the user. That is, in the following, the user may be interpreted as the terminal device 10. The terminal device 10 as described above is implemented by, for example, a smartphone, a tablet terminal, a notebook personal computer (PC), a desktop PC, a mobile phone, a personal digital assistant (FDA), or the like.

The distribution apparatus 100 is an information processing apparatus that provides the distribution service to distribute the display candidate advertisements to the terminal device 10. The distribution apparatus 100 accepts an advertisement request from the terminal device 10. For example, the distribution apparatus 100 accepts an advertisement request from an application that operates on the terminal device 10. Furthermore, the distribution apparatus 100 has, as advertisement information, a predetermined advertisement group including a plurality of advertisements to which order of priorities is assigned. Assignment of the order to the advertisements in the advertisement information will be described in detail later. The distribution apparatus 100 extracts display candidate advertisements from the advertisement information. For example, upon accepting the advertisement request from the terminal device 10, the distribution apparatus 100 distributes, to the terminal device 10, the display candidate advertisements extracted from the predetermined advertisement group based on the user application information.

As illustrated in FIG. 1, the user activates an application installed in the terminal device 10 (Step S11). In the example illustrated in FIG. 1, the user activates an application X installed in the terminal device 10. If, for example, an application screen C10 of the activated application X contains an advertisement display area AR10, the terminal device 10 transmits an advertisement request to the distribution apparatus 100 (Step S12).

Upon accepting the advertisement request from the terminal device 10, the distribution apparatus 100 extracts display candidate advertisements from the advertisement information (Step S13). For example, the distribution apparatus 100 extracts, as the display candidate advertisements, four advertisements from the advertisement information. In the example illustrated in FIG. 1, the distribution apparatus 100 extracts, as the display candidate advertisements, an advertisement for an application A, an advertisement for an application B, an advertisement for an application C, and an advertisement for an application D from the advertisement information. The distribution apparatus 100 extracts the display candidate advertisements from the predetermined advertisement group (the advertisement information in the example in FIG. 1) based on the user application information, which will be described in detail later. Subsequently, the distribution apparatus 100 distributes the display candidate advertisements to the terminal device 10 (Step S14). At this time, the distribution apparatus 100 distributes the display candidate advertisements to the terminal device 10 in order specified in the advertisement information as illustrated in FIG. 1, that is, the advertisement for the application A is the first priority, the advertisement for the application B is the second priority, the advertisement for the application C is the third priority, and the advertisement for the application D is the fourth priority.

Upon receiving the display candidate advertisements from the distribution apparatus 100, the terminal device 10 performs a selection process of selecting a display target advertisement as an advertisement to be displayed on the terminal device 10 from among the display candidate advertisements (Step S15). In the example illustrated in FIG. 1, the terminal device 10 selects the advertisement for the application B in the selection process. Details of the selection process will be described below.

First, in the example illustrated in FIG. 1, the application A, the application C, an application E, and an application J, except for the application B and the application D, are installed in the terminal device 10. That is, in the example illustrated in FIG. 1, among the application A, the application B, the application C, and the application D as the applications corresponding to the display candidate advertisements, the application A and the application C are applications that are installed in the terminal device 10 (hereinafter, may be referred to as “installed applications”), and the application B and the application D are application that are not installed in the terminal device 10 (hereinafter, may be referred to as “non-installed applications”).

In the selection process at Step S15, the terminal device 10 excludes the advertisements for the installed applications from the display candidate advertisements. That is, in the example illustrated in FIG. 1, the terminal device 10 excludes the advertisement for the application A that is the installed application and the advertisement for the application C that is the installed application from the display candidate advertisements. Therefore, the advertisements for the applications other than the installed applications remain as the display candidate advertisements. In the example illustrated in FIG. 1, the advertisement for the application B as the non-installed application and the advertisement for the application D as the non-installed application remain as the display candidate advertisements.

The terminal device 10 selects, as a display target advertisement, an advertisement with a higher priority from among the display candidate advertisements except for the advertisements for the installed applications. In the example illustrated in FIG. 1, the advertisement for the application B with the second priority and the advertisement for the application D with the fourth priority remain as the display candidate advertisements after exclusion of the advertisements for the installed applications. Therefore, the terminal device 10 selects the advertisement for the application B with a higher priority. Subsequently, the terminal device 10 displays the advertisement selected through the selection process (Step S16). In the example illustrated in FIG. 1, the terminal device 10 displays an advertisement content AC2 for the application B in the advertisement display area AR10 on the application screen C10 of the activated application X.

Furthermore, the terminal device 10 transmits, to the distribution apparatus 100, information on installation of the applications of the distributed display candidate advertisements (Step S17). Specifically, the terminal device 10 transmits, to the distribution apparatus 100, information on installation or non-installation of the applications corresponding to the distributed display candidate advertisements. In the example illustrated in FIG. 1, the terminal device 10 transmits, to the distribution apparatus 100, information indicating that the application A and the application C are already installed among the application A, the application B, the application C, and the application D that are the applications corresponding to the distributed display candidate advertisements. Thereafter, upon accepting an advertisement request from the terminal device 10, the distribution apparatus 100 extracts display candidate advertisements based on the user application information to which the information on the applications corresponding to the distributed display candidate advertisements accepted from the terminal device 10 is added. For example, the distribution apparatus 100 extracts, as the display candidate advertisements, advertisements except for the advertisement for the application A and the advertisement for the application C installed in the terminal device 10.

As described above, in the distribution system 1 according to the embodiment, the distribution apparatus 100 distributes a plurality of advertisements as the display candidate advertisements to the terminal device 10. The terminal device 10 that has received the display candidate advertisements selects, as a display target advertisement, an advertisement for a non-installed application from among the display candidate advertisements. Then, the terminal device 10 displays the display target advertisement. That is, even when the installation status of applications in the terminal device 10 is not recognized, the distribution apparatus 100 can distribute an appropriate advertisement by distributing a plurality of advertisements to the terminal device 10 that selects an advertisement for a non-installed application as the display target advertisement. Therefore, the distribution apparatus 100 can improve the advertising effect. For example, in the distribution system 1, even if an advertisement for an installed application is displayed on the terminal device 10, it may be difficult to improve the effect of the advertisement because the application is already installed in the terminal device 10. In this case, the terminal device 10 selects an advertisement for a non-installed application as the display target advertisement from among the display candidate advertisements. Then, the terminal device 10 displays the advertisement for the non-installed application as the display target advertisement to increase the possibility that the application may be installed in the terminal device 10. Therefore, the distribution system 1 can improve the advertising effect. Furthermore, the distribution system 1 can display an appropriate advertisement on the terminal device 10 depending on the installation status of applications in the terminal device 10 at the time of distribution. Therefore, the distribution system 1 can improve the advertising effect.

Moreover, the distribution apparatus 100 distributes a plurality of advertisements to which priorities are assigned, as the display candidate advertisements, to the terminal device 10. Then, the terminal device 10 selects, as the display target advertisement, an advertisement with a higher priority from among the display candidate advertisements, and displays the display target advertisement. That is, the distribution apparatus 100 can distribute an appropriate advertisement by distributing a plurality of advertisements to the terminal device 10 that selects an advertisement with a higher priority. Therefore, the distribution apparatus 100 can improve the advertising effect. Furthermore, the distribution apparatus 100 assigns priorities to a plurality of advertisements based on certain criteria for various purposes, so that it becomes possible to distribute advertisements according to the purposes. For example, the distribution apparatus 100 may assign a higher priority for a higher click through rate (CTR) indicating a rate at which an advertisement is clicked, so that the advertisement displayed on the terminal device 10 is likely to be clicked and the advertising effect can be improved. The distribution apparatus 100 may assign a higher priority for a higher fee for displaying an advertisement, so that benefits from distribution of advertisements can be increased. In the above-described example, the terminal device 10 selects, as the display target advertisement, an advertisement that is for a non-installed application and that has a higher priority from among the display candidate advertisements. Therefore, the distribution apparatus 100 can improve the effect for a certain purpose based on which the priorities are assigned, and can improve the advertising effect. Furthermore, the distribution apparatus 100 accepts, from the terminal device 10, information on installation or non-installation of only applications corresponding to the distributed display candidate advertisements. For example, when distributing three advertisements as the display candidate advertisements, the distribution apparatus 100 accepts, from the terminal device 10, information on installation or non-installation of only applications corresponding to the three distributed advertisements. Therefore, the distribution apparatus 100 can reduce psychological resistance of the user of the terminal device 10, can improve the advertising effect, and can promote use of the advertisement distribution by the distribution apparatus 100.

2. Configuration of Distribution Apparatus

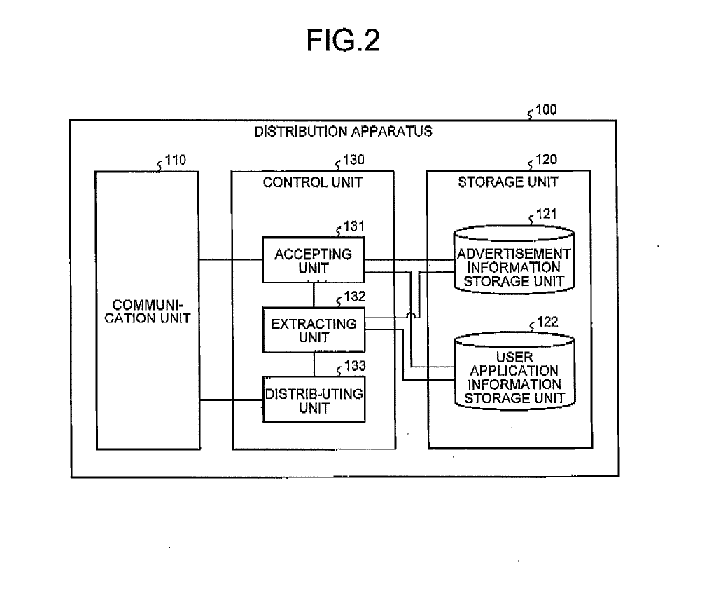

A configuration of the distribution apparatus 100 according to the embodiment will be described below with reference to FIG. 2. FIG. 2 is a diagram illustrating a configuration example of the distribution apparatus 100 according to the embodiment. As illustrated in FIG. 2, the distribution apparatus 100 includes a communication unit 110, a storage unit 120, and a control unit 130. The distribution apparatus 100 may include an input unit (for example, a keyboard, a mouse, or the like) that accepts various types of operation from an administrator or the like of the distribution apparatus 100, or a display unit (for example, a liquid crystal display or the like) that displays various types of information.

The communication unit 110 is implemented by, for example, a network interface card (NIC) or the like. The communication unit 110 is connected to a network by wire or wireless, and transmits and receives information to and from the terminal device 10.

Storage Unit 120

The storage unit 120 is implemented by, for example, a semiconductor memory device, such as a random access memory (RAM) or a flash memory, or a storage device, such as a hard disk or an optical disk. As illustrated in FIG. 2, the storage unit 120 according to the embodiment includes an advertisement information storage unit 121 and a user application information storage unit 122.

Advertisement Information Storage Unit 121

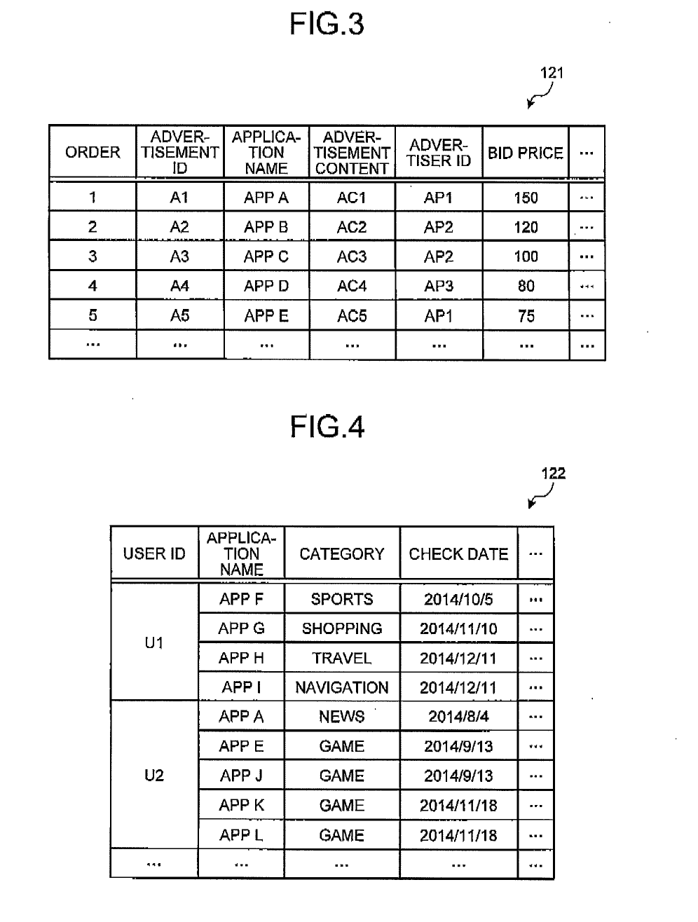

The advertisement information storage unit 121 according to the embodiment stores therein various types of information on advertisements. FIG. 3 illustrates an example of the advertisement information storage unit 121 according to the embodiment. The advertisement information storage,unit 121 illustrated in FIG. 3 contains items of “order”, “advertisement ID”, “application name”, “advertisement content”, “advertiser ID”, and “bid price”.

The “order” indicates a priority of each of advertisements in the advertisement information. In the example illustrated in FIG. 3, the priority of each of the advertisements is increased with an increase in a bid price to be described later. In the example illustrated in FIG. 3, the advertisement for the application A identified by an advertisement ID of “A1” has the first priority, that is, the advertisement for the application A is an advertisement with the highest priority. The “order” may be determined based on not only the bid price but also various other conditions. Furthermore, the “order” may be different for each user. For example, in the “order”, priorities may be assigned in order from the highest expected earnings from an advertisement for an application for each user. For example, for a user who tends to attempt to install a number of applications, it may be possible to place emphasis on the bid price rather than the content or the like of an application and to assign a higher priority to an advertisement for an application with a higher bid price so that the advertisement with the higher bid price can easily be distributed. Furthermore, for a user who tends not to attempt installation, it may be possible to assign a higher priority to an advertisement suitable for the user based on an installation history or the like of the user so that an advertisement for an application of a category that the user is likely to install can easily be distributed. Moreover, it may be possible to assign priorities based on analysis of types of installed applications, the number of activations of the applications, a tendency in terms of activation duration for each user.

The “advertisement ID” indicates an identification information for identifying an advertisement. The “application name” indicates a name of an application as a target of the advertisement. In the example illustrated in FIG. 3, the advertisement with the advertisement ID of “A1” is an advertisement with an application name of “application A”. The information for identifying each application is not limited to the “application name”, but information, such as the “application ID”, for identifying each application may be stored.

The “advertisement content” indicates a content of an advertisement submitted from an advertiser. In FIG. 3, an example is illustrated in which conceptual information, such as “AC1”, is stored in the “advertisement content”. However, in reality, a still image, a moving image, text data, a uniform resource locator (URL), a file path name indicating a storage location of the above-described image or data, or the like is stored. The “advertiser ID” indicates identification information for identifying an advertiser. In the example illustrated in FIG. 3, an advertise of the advertisement with the advertisement ID of “A1” is an advertiser identified by an advertiser ID of “AP1”.

The “bid price” indicates an advertisement fee specified when an advertiser submits an advertisement content. For example, the “bid price” corresponds to a unit price to be paid from an advertiser to an advertisement distributor (for example, the administrator of the distribution apparatus 100) when the advertisement content is clicked once by a user, that is, corresponds to a so-called cost per click (CPC). Incidentally, the “bid price” may be any price information that can be compared between advertisements in the advertisement information. For example, a price per thousand displays of an advertisement, that is, a so-called cost per mile (CPM), may be employed. Furthermore, a so-called effective cost per mile (eCPM) indicating earnings per thousand displays of an advertisement.

User application information storage unit 122

The user application information storage unit 122 according to the embodiment stores therein user application information for each user. FIG. 4 illustrates an example of the user application information stored in the user application information storage unit 122. As illustrated in FIG. 4, the user application information storage unit 122 contains, as the user application information, items of “user ID”, “application name”, “category”, and “check date”.

The “user ID” is identification information for identifying a user. For example, a user identified by a user ID of “U1” corresponds to the user illustrated in the example in FIG. 1. The “application name” indicates a name of an application to be a target of an advertisement. In the example illustrated in FIG. 4, it is indicated that the user with the user ID of “U1” (hereinafter, may be referred to as the “user U1”) has already installed four applications such as an application F, an application G, an application H, and an application I. The information for identifying each application is not limited to the “application name”, but information, such as the “application ID”, for identifying an application may be stored.

The “category” indicates a category into which each application is classified according to a content of the application. In the example illustrated in FIG. 4, the application F is classified into a category of “sports”, and the application A is classified into a category of “news”. Incidentally, as the “category”, for example, it may be possible to employ a category conforming to a category for classifying a predetermined application, such as a category for classifying an applications provided by Android (registered trademark) or an iOS (registered trademark).

The “check date” indicates a date on which it is confirmed that an application is already installed. In the example illustrated in FIG. 4, the check date of “2014/10/5” on the first line indicates that it is confirmed on Oct. 5, 2014 that the application F is already installed in the terminal device 10 of the user U1. Furthermore, the check date of “2014/8/4” on the fifth line indicates that it is confirmed on Aug. 4, 2014 that the application A is already installed in a terminal device of a user U2. Incidentally, as for the “check date”, it may be possible to store information including hours and times in addition to the date.

Control Unit 130

Referring back to FIG. 2, the control unit 130 is implemented by, for example, executing various programs (corresponding to an example of a distribution program) stored in an internal storage device of the distribution apparatus 100 by a central processing unit (CPU), a micro processing unit (MPU), or the like by using a RAM as a work area. The control unit 130 may be implemented by, for example, an integrated circuit, such as an application specific integrated circuit (ASIC) or a field programmable gate array (FPGA).

As illustrated in FIG. 2, the control unit 130 includes an accepting unit 131, an extracting unit 132, and a distributing unit 133, and implements or executes functions and operations of information processing as described below. Incidentally, the internal configuration of the control unit 130 is not limited to the configuration as illustrated in FIG. 2, and any other configuration that performs the information processing as described below is applicable. Furthermore, a connection relation between processing units of the control unit 130 is not limited to the connection relation as illustrated in FIG. 2, and any other connection relation is applicable.

Accepting Unit 131

The accepting unit 131 accepts an advertisement request from the terminal device 10. In the embodiment, the accepting unit 131 accepts an advertisement request by an application that operates on the terminal device 10. Furthermore, the accepting unit 131 accepts the user application information corresponding to the display candidate advertisements from the terminal device 10 to which the display candidate advertisements are distributed. For example, the accepting unit 131 accepts, as the user application information, information on installation or non-installation of applications corresponding to the display candidate advertisements. Upon accepting the information on installation or non-installation of the applications corresponding to the distributed display candidate advertisements, the accepting unit 131 stores the information on the installation or non-installation of the applications in the user application information storage unit 122. Furthermore, upon accepting information on installation of an application, the accepting unit 131 stores the information on installation of the application in the user application information storage unit 122. For example, when an application corresponding to the display target advertisement displayed on the terminal device 10 is installed in the terminal device 10, the accepting unit 131 may accept information on installation of the application corresponding to the display target advertisement from the terminal device 10, and may store, as the installed application, the application corresponding to the display target advertisement in the user application information storage unit 122.

Extracting Unit 132

The extracting unit 132, when the accepting unit 131 accepts an advertisement request, extracts display candidate advertisements from a predetermined advertisement group based on the user application information. Specifically, the extracting unit 132 extracts the display candidate advertisements from the advertisement information stored in the advertisement information storage unit 121 on the basis of the user application information stored in the user application information storage unit 122. For example, the extracting unit 132 extracts, from the advertisement information, the display candidate advertisements except for advertisements for applications installed in the terminal device 10.

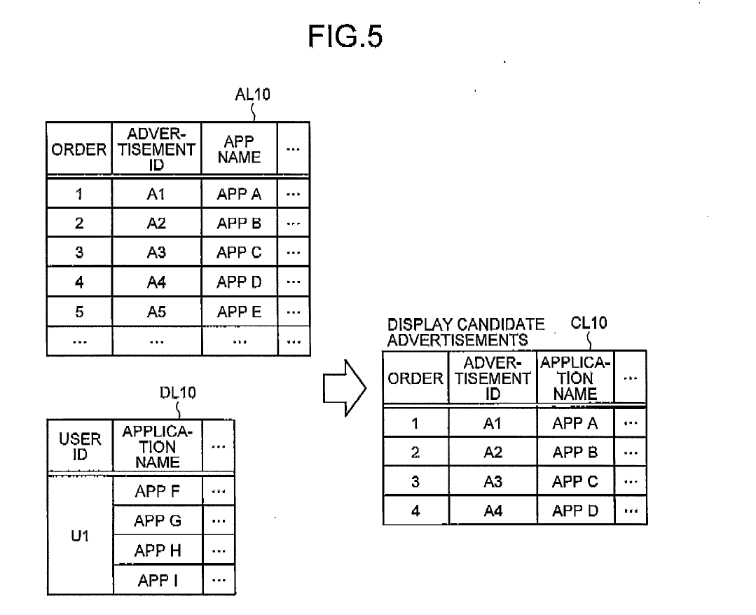

Extraction of the display candidate advertisements by the extracting unit 132 will be described below. FIG. 5 is a diagram illustrating an example of the extraction of the display candidate advertisements. FIG. 5 illustrates an example in which the display candidate advertisements for the user U1 are extracted similarly to FIG. 1. Furthermore, in the example illustrated in FIG. 5, the extracting unit 132 extracts four advertisements as the display candidate advertisements from advertisement information AL10.

The advertisement information AL10 illustrated in FIG. 5 corresponds to the advertisement information stored in the advertisement information storage unit 121, and indicates only information on items needed for explanation. Specifically, the advertisement information AL10 indicates the order, the advertisement ID, and the application name in the advertisement information. The advertisement information AL10 in FIG. 5 contains the advertisement for the application A with the first priority, the advertisement for the application B with the second priority, the advertisement for the application C with the third priority, the advertisement for the application D with the fourth priority, an advertisement for the application E with the fifth priority, and the like.

Furthermore, user application information DL10 illustrated in FIG. 5 corresponds to the user application information stored in the user application information storage unit 122 illustrated in FIG. 4, and indicates only information on items needed for explanation. Specifically, the user application information DL10 indicates the user ID and the application name in the user application information. The user application information DL10 in FIG. 5 indicates that the application F, the application G, the application H, and the application I are already installed in the terminal device 10 of the user U1.

The extracting unit 132 extracts, from the advertisement information AL10, the display candidate advertisements except for applications contained in the user application information DL10. For example, if the user application information DL10 contains the application A, the advertisement for the application A is not extracted as the display candidate advertisement from the advertisement information AL10 although the advertisement for the application A has the first priority.

In the example illustrated in FIG. 5, the user application information DL10 does not contain the applications A, B, C, and D corresponding to four advertisements with the first to the fourth priorities in the advertisement information AL10. Therefore, in FIG. 5, the advertisement for the application A, the advertisement for the application B, the advertisement for the application C, and the advertisement for the application D are extracted as display candidate advertisements CL10 in the same order as in the advertisement information AL10. That is, the extracting unit 132 extracts the display candidate advertisements CL10 such that the advertisement for the application A is the first priority, the advertisement for the application B is the second priority, the advertisement for the application C is the third priority, and the advertisement for the application D is the fourth priority. Incidentally, details of a process to be performed when the user application information DL10 contains an application to which a higher priority is assigned in the advertisement information AL10 will be described later.

Distributing Unit 133

The distributing unit 133, when the accepting unit 131 accepts an advertisement request, distributes the display candidate advertisements to the terminal device 10 that selects a display target advertisement based on information on installed applications from among the display candidate advertisements that are a plurality of advertisements as candidates to be displayed. In the embodiment, the distributing unit 133 distributes the display candidate advertisements extracted by the extracting unit 132 to the terminal device 10. In the example illustrated in FIG. 5, the distributing unit 133 distributes the display candidate advertisements CL10 extracted by the extracting unit 132 to the terminal device 10. Specifically, the distributing unit 133 distributes, to the terminal device 10, the display candidate advertisement CL10 such that the advertisement for the application A is the first priority, the advertisement for the application B is the second priority, the advertisement for the application C is the third priority, and the advertisement for the application D is the fourth priority.

3. Configuration of Terminal Device

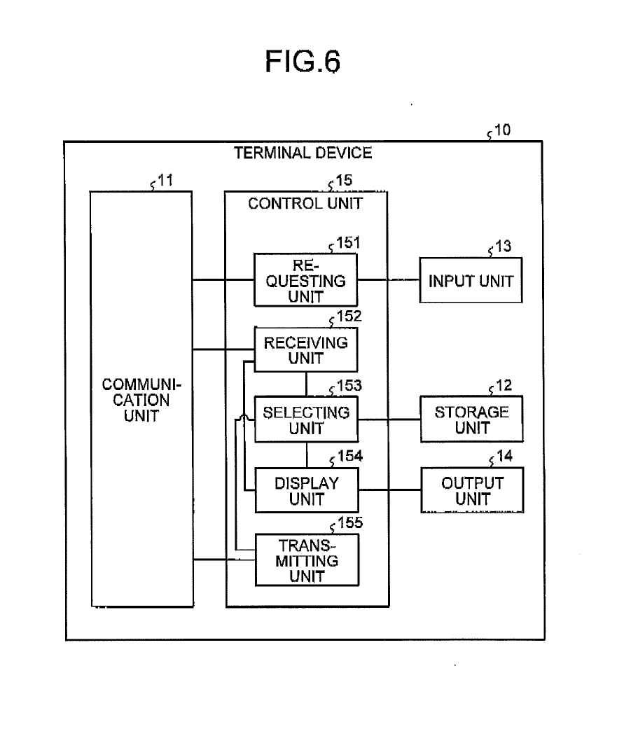

With reference to FIG. 6, a configuration of the terminal device 10 according to the embodiment will be described below. FIG. 6 is a diagram illustrating a configuration example of the terminal device 10 according to the embodiment. As illustrated in FIG. 6, the terminal device 10 includes a communication unit 11, a storage unit 12, an input unit 13, an output unit 14, and a control unit 15.

Communication Unit 11

The communication unit 11 is implemented by, for example, a communication circuit or the like. The communication unit 11 is connected to a predetermined communication network (not illustrated) by wire or wireless, and transmits and receives information to and from the distribution apparatus 100.

Storage Unit 12

The storage unit 12 is implemented by, for example, a semiconductor memory device, such as a RAM or a flash memory, or a storage device, such as a hard disk or an optical disk. The storage unit 12 stores therein, for example, information, such as a program, on an application installed in the terminal device 10.

Input Unit 13

The input unit 13 accepts various types of operation from a user. For example, the input unit 13 may accept various types of operation from a user via a display screen by using a touch panel function. Furthermore, the input unit 13 may accept various types of operation from a button provided in the terminal device 10 or a keyboard or a mouse connected to the terminal device 10.

Output Unit 14

The output unit 14 is a display screen of a tablet terminal or the like, is implemented by, for example, a liquid crystal display or an organic electro-luminescence (EL) display, and is a display device for displaying various types of information.

Control Unit 15

The control unit 15 is implemented by, for example, executing various programs stored in a storage device, such as the storage unit 12, in the terminal device 10 by a CPU, an MPU, or the like by using a RAM as a work area. For example, the various programs include a program of an installed application. The control unit 15 may be implemented by, for example, an integrated circuit, such as an ASIC or an FPGA.

As illustrated in FIG. 6, the control unit 15 includes a requesting unit 151, a receiving unit 152, a selecting unit 153, a display unit 154, and a transmitting unit 155, and implements or executes functions and operations of a selection process as described below. Incidentally, the internal configuration of the control unit 15 is not limited to the configuration as illustrated in FIG. 6, and any other configuration that performs the selection process as described below is applicable. Furthermore, a connection relation between processing units of the control unit 15 is not limited to the connection relation as illustrated in FIG. 6, and any other connection relation is applicable.

The requesting unit 151 transmits an advertisement request to the distribution apparatus 100 in accordance with user operation accepted by the input unit 13. For example, when an application screen of an activated application contains an advertisement display area, the requesting unit 151 transmits the advertisement request to the distribution apparatus 100.

The receiving unit 152 receives a plurality of advertisements. In the embodiment, the receiving unit 152 receives the display candidate advertisements from the distribution apparatus 100. In the example illustrated in FIG. 5, the receiving unit 152 receives the display candidate advertisements CL10 from the distribution apparatus 100. Specifically, the receiving unit 152 receives, from the distribution apparatus 100, the display candidate advertisement CL10 such that the advertisement for the application A is the first priority, the advertisement for the application B is the second priority, the advertisement for the application C is the third priority, and the advertisement for the application D is the fourth priority. Furthermore, when receiving the display candidate advertisements, the receiving unit 152 may store the display candidate advertisements in the storage unit 12.

The selecting unit 153 performs the selection process of selecting a display target advertisement from among the display candidate advertisements received by the receiving unit 152, on the basis of the information on the installed applications. In the embodiment, the selecting unit 153 selects, as the display target advertisement, an advertisement for a non-installed application from among a plurality of the advertisements received by the receiving unit 152.

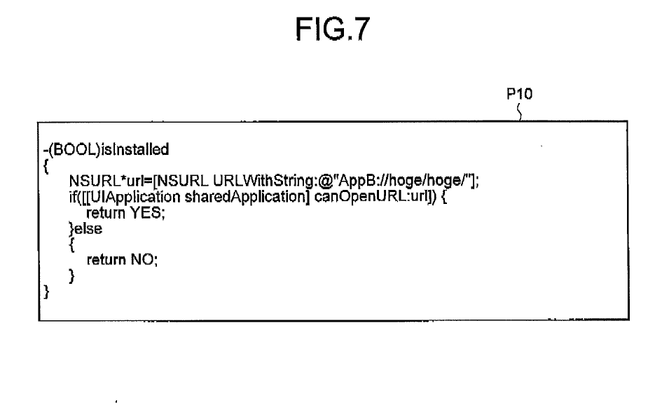

For example, the selecting unit 153 acquires the information on the installed applications through a process as described below. When an operating system (OS) of the terminal device 10 is Android (registered trademark) or iOS (registered trademark), it is possible to confirm whether an application is installed by checking whether the application is activatable by using a URL scheme. FIG. 7 is a diagram illustrating a specific example of confirmation of installation of an application. FIG. 7 illustrates an example in which the terminal device 10 using iOS (registered trademark) as an OS checks whether an application is installed by using a URI, scheme. In the example illustrated in FIG. 7, whether the application B (“AppB” in FIG. 7) is activatable by the URL scheme is confirmed by using a program P10. If it is confirmed by this check that the application B is activatable, it is confirmed that the application B is already installed in the terminal device 10. Furthermore, if it is confirmed that the application B is not activatable, it is confirmed that the application B is not installed in the terminal device 10. In the case of Android (registered trademark), it is possible to confirm installation or non-installation of an application by using a function of getInstalledApplications of PackageManager class, a function of getApplicationInfo, or the like, in addition to the process as described above.

The selecting unit 153 can acquire the information on the installed applications by performing the above-described process on each of the applications corresponding to the display candidate advertisements. In the example illustrated in FIG. 1, the selecting unit 153 can confirm that the application A and the application C are already installed by performing the above-described process on the application A, the application B, the application C, and the application D. Furthermore, the selecting unit 153 can confirm that the application B and the application D are not installed.

In the example illustrated in FIG. 5, the selecting unit 153 selects, as the display target advertisement, an advertisement related to a non-installed application from among the display candidate advertisements CL10. Specifically, the selecting unit 153 selects, as the display target advertisement, an advertisement for an application that is not installed and that has the highest priority from among the display candidate advertisements CL10. For example, when the application A is not installed in the terminal device 10, the selecting unit 153 selects, as the display target advertisement, the advertisement for the application A with the first priority. For another example, as illustrated in FIG. 1, when the application A is installed in the terminal device 10, the selecting unit 153 excludes the advertisement for the application A. Then, the selecting unit 153 selects, as the display target advertisement, an advertisement with the second highest priority relative to the application A, that is the advertisement for the application B with the second priority.

The display unit 154 displays an application screen of the activated application. Furthermore, when the application screen of the activated application contains an advertisement display area, the display unit 154 displays the display target advertisement selected by the selecting unit 153 in the advertisement display area. In the example illustrated in FIG. 1, the display unit 154 displays an advertisement content AC2 for the application B in the advertisement display area AR10 of the application screen C10 of the activated application X.

The transmitting unit 155 transmits information on applications corresponding to a plurality of advertisements to the distribution apparatus 100 that distributes a plurality of advertisements. In the embodiment, the transmitting unit 155 transmits the information on the applications corresponding to the display candidate advertisements to the distribution apparatus 100. In the example illustrated in FIG. 1, the transmitting unit 155 transmits, to the distribution apparatus 100, information indicating that the application A and the application C are already installed among the application A, the application B, the application C, and the application D corresponding to the display candidate advertisements.

Incidentally, the process such as the selection process performed by the control unit 15 as described above may be performed by, for example, JavaScript (registered trademark). Furthermore, when the above-described selection process is performed by a predetermined application or when the selection process is performed by a dedicated application, the control unit 15 may include, for example, an application control unit that controls the predetermined application or the dedicated application.

4. Flow of Distribution Process

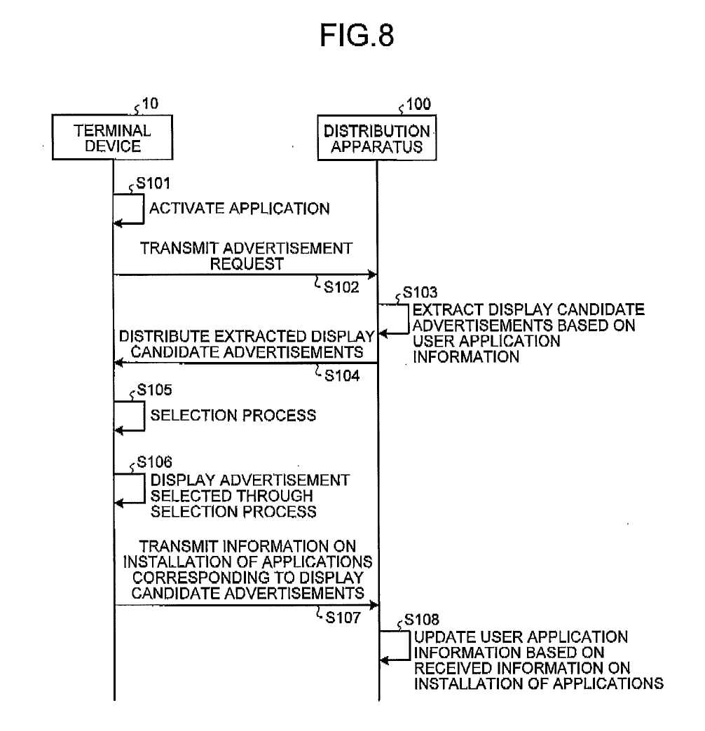

The flow of the distribution process performed by the distribution system 1 according to the embodiment will be described below with reference to FIG. 8. FIG. 8 is a sequence diagram illustrating the flow of the distribution process performed by the distribution system 1 according to the embodiment.

As illustrated in FIG. 8, the terminal device 10 activates an installed application according to operation by a user (Step S101). If the activated application contains an advertisement request, the terminal device 10 transmits the advertisement request to the distribution apparatus 100 (Step S102). For example, if the application screen of the activated application contains an advertisement display area, the terminal device 10 transmits an advertisement request to the distribution apparatus 100.

Upon accepting the advertisement request from the terminal device 10, the distribution apparatus 100 extracts display candidate advertisements based on the user application information (Step S103). For example, the distribution apparatus 100 extracts, as the display candidate advertisements, advertisements for applications that are not contained in the user application information from the advertisement information. Thereafter, the distribution apparatus 100 transmits the extracted display candidate advertisements to the terminal device 10 (Step S104).

Upon receiving the display candidate advertisements from the distribution apparatus 100, the terminal device 10 performs the selection process of selecting a display target advertisement from among the display candidate advertisements (Step S105). For example, the terminal device 10 selects, as the display target advertisement, an advertisement for an application that is not installed and that has the highest priority from among the display candidate advertisements. Then, the terminal device 10 displays the display target advertisement selected through the selection process (Step S106). Furthermore, the terminal device 10 transmits information on installation of applications corresponding to the distributed display candidate advertisements to the distribution apparatus 100 (Step S107). For example, the terminal device 10 transmits, as the information on the installation of the applications corresponding to the distributed display candidate advertisements, information on installed applications among the applications corresponding to the distributed display candidate advertisements to the distribution apparatus 100.

Then, upon accepting the information on the installation of the applications corresponding to the distributed display candidate advertisements, the distribution apparatus 100 updates the user application information based on the accepted information on the installation of the applications corresponding to the distributed display candidate advertisements (Step S108). Thereafter, the distribution apparatus 100 extracts display candidate advertisements based on the updated user application information. Hereinafter, update of the user application information and extraction of display candidate advertisements based on the updated user application information will be described below.

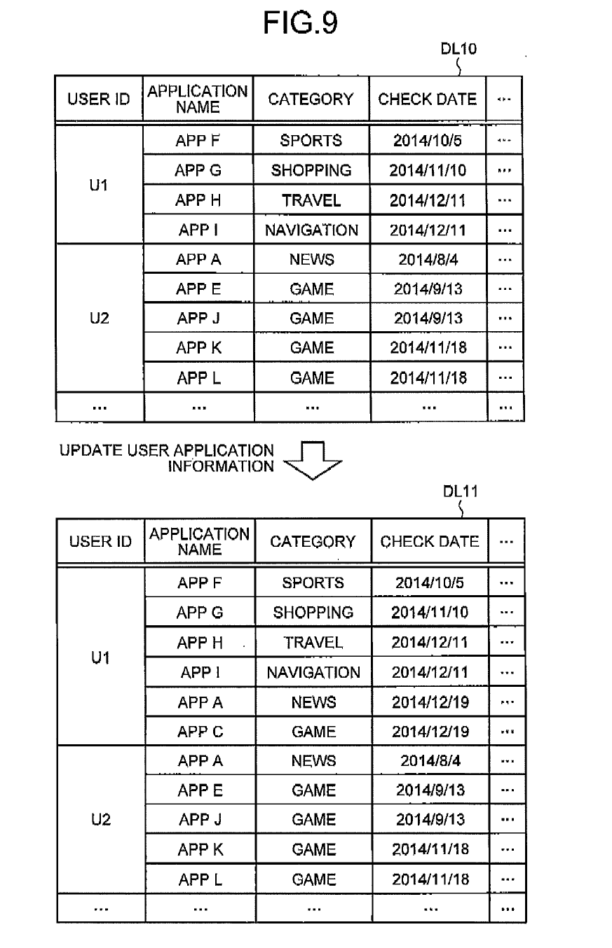

FIG. 9 is a diagram illustrating an example of update of the user application information according to the embodiment. The user application information DL10 illustrated in FIG. 9 is user application information before update, and corresponds to the user application information stored in the user application information storage unit 122 illustrated in FIG. 4, similarly to the user application information DL10 illustrated in FIG. 5. Specifically, the user application information DL10 in FIG. 9 indicates that the application F, the application G, the application H, and the application I are already installed in the terminal device 10 of the user U1.

Furthermore, user application information DL11 illustrated in FIG. 9 indicates updated user application information. The updated user application information DL11 is user application information obtained by performing user application information update on the user application information DL10. As described above, upon accepting the information on the installation of the applications corresponding to the distributed display candidate advertisements, the distribution apparatus 100 updates the user application information based on the accepted information on the installation of the applications corresponding to the distributed display candidate advertisements.

In the example illustrated in FIG. 9, similarly to FIG. 1, the distribution apparatus 100 has received, from the terminal device 10 of the user U1, information indicating that the application A and the application C are already installed among the application A, the application 3, the application C, and the application D that are applications corresponding to the distributed display candidate advertisements. In this case, the distribution apparatus 100 adds, to the user application information an the user U1, information indicating that the application A and the application C are already installed. Accordingly, the distribution apparatus 100 updates the user application information DL10 to the user application information DL11. The updated user application information DL11 in FIG. 9 indicates that the application F, the application G, the application H, the application I, the application A, and the application C are already installed in the terminal device 10 of the user U1.

As illustrated in FIG. 9, the distribution apparatus 100 adds, to the user application information, the accepted information on the installation of the applications corresponding to the distributed display candidate advertisements. That is, even when an application that has been added as the installed application once is uninstalled, the user application information contains the application as the installed application. Therefore, the distribution apparatus 100 can prevent distribution of an advertisement for the application to the terminal device 10 of the user. For example, it is estimated that a user who has uninstalled a once-installed application is less likely to re-install the same application; therefore, by preventing distribution of an advertisement for the uninstalled application to the user who has performed the uninstallation, the distribution apparatus 100 can improve the advertising effect. Incidentally, the distribution apparatus 100 may acquire the information on an installation history of the terminal device 10 from a software or the like provided by a predetermined application distributor. Accordingly, the distribution apparatus 100 can acquire the installation history, of applications that are uninstalled before distributing advertisements for applications as the display candidate advertisements, and can employ the applications as the installed applications.

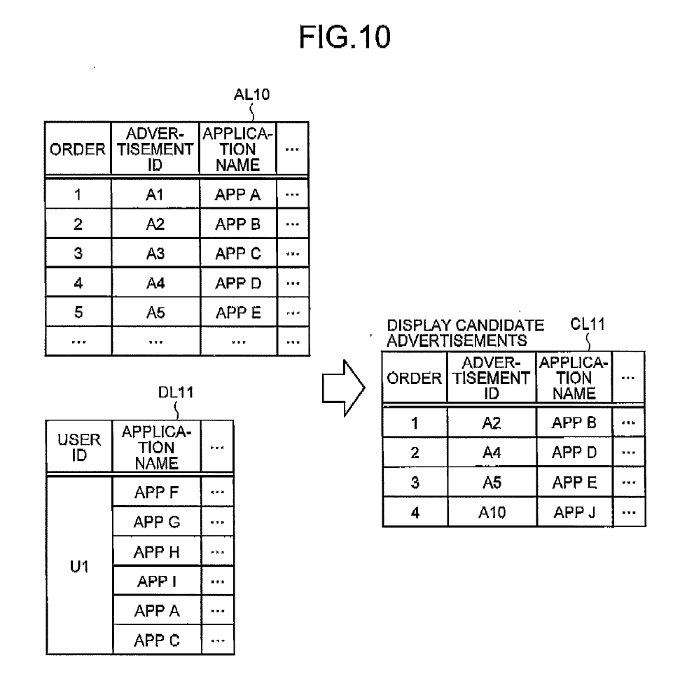

Next, extraction of display candidate advertisements using the updated user application information DL11 will be described below with reference to FIG. 10. FIG. 10 is a diagram illustrating an example of the extraction of the updated display candidate advertisements. The advertisement information AL10 illustrated in FIG. 10 is the same as the advertisement information AL10 illustrated in FIG. 5, corresponds to the advertisement information stored in the advertisement information storage unit 121 illustrated in FIG. 3, and indicates only information on items needed for explanation.

Furthermore, the updated user application information DL11 illustrated in FIG. 10 corresponds to the updated user application information DL11 illustrated in FIG. 9, and indicates information on items needed for explanation. Specifically, the updated user application information DL11 illustrated in FIG. 10 indicates the user ID and the application name in the user application information. As described above, the updated user application information DL11 indicates that the application F, the application G, the application H, the application I, the application A, and the application C are already installed in the terminal device 10 of the user U1.

Incidentally, the distribution apparatus 100 extracts, from the advertisement information AL10, the display candidate advertisements CL11 except for the applications contained in the updated user application information DL11. In the example illustrated in FIG. 10, the updated user application information DL11 contains the application A and the application C among the applications A, B, C, and D corresponding to the four advertisements with the first to the fourth priority in the advertisement information AL10. Therefore, in FIG. 10, the advertisement for the application B and the advertisement for the application D are extracted as the display candidate advertisements CL11, but the advertisement for the application A and the advertisement for the application C are not extracted as the display candidate advertisements CL11. Then, the distribution apparatus 100 extracts two other advertisements as the display candidate advertisements CL11 from among advertisements with the fifth and lower priorities. The distribution apparatus 100 extracts, as the display candidate advertisement CL11, an advertisement for an application that is not contained in the updated user application information all and that has the highest priority from among the advertisements with the fifth and lower priorities. In FIG. 10, the distribution apparatus 100 extracts, as the display candidate advertisement CL11, the advertisement for the application E that has the fifth priority and that is not contained in the updated user application information DL11, and extracts an advertisement for the application J that has the sixth or lower priority (for example, the tenth priority) and that is not contained in the updated user application information DL11. Therefore, when extracting the display candidate advertisements CL11 based on the updated user application information DL11, the distribution apparatus 100 extracts the display candidate advertisements CL11 such that the advertisement for the application B is the first priority, the advertisement for the application D is the second priority, the advertisement for the application E is the third priority, and the advertisement for the application J is the fourth priority.

In contrast, as illustrated in FIG. 5, when extracting the display candidate advertisements CL10 based on the user application information DL10 before update, the distribution apparatus 100 extracts the display candidate advertisements CL10 such that the advertisement for the application A is the first priority, the advertisement for the application B is the second priority, the advertisement for the application C is the third priority, and the advertisement for the application D is the fourth priority. As described above, by updating the user application information based on installation or non-installation of applications corresponding to the distributed display candidate advertisements accepted from the terminal device 10, the distribution apparatus 100 extracts the display candidate advertisements more suitable for the user of the terminal device 10.

5. Modifications

The distribution system 1 according to the above-described embodiment may be embodied in various forms other than the above-described embodiment. Other embodiments of the distribution system 1 will be described below.

5-1. Distribution of Advertisement for Installed Application

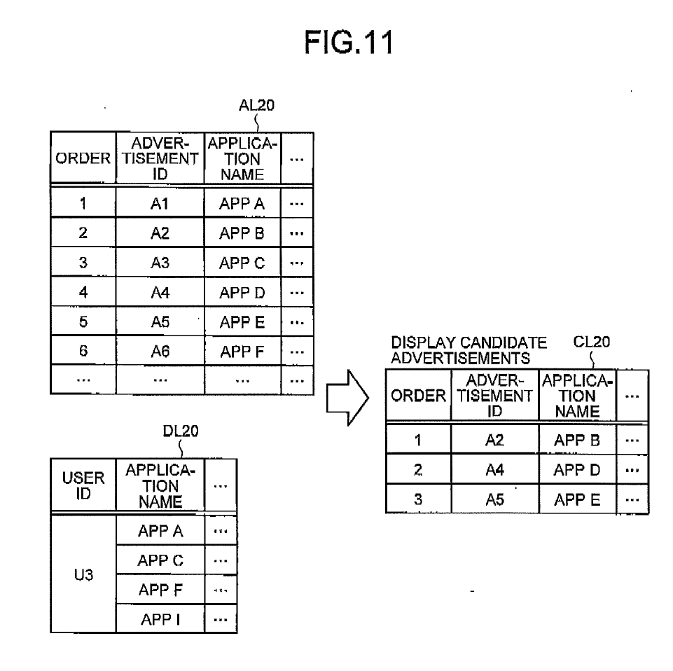

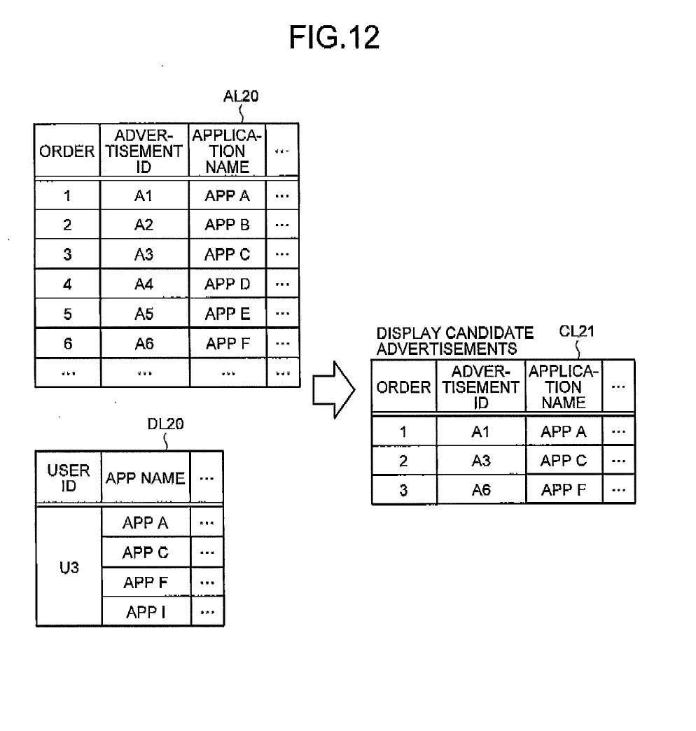

In the above-described embodiment, the distribution apparatus 100 extracts, as the display candidate advertisements, advertisements for applications that are not installed in the terminal device 10 from the advertisement information. However, the distribution apparatus 100 may extract, as the display candidate advertisements, advertisements for applications installed in the terminal device 10 from the advertisement information. This will be described below with reference to FIG. 11 and FIG. 12. FIG. 11 and FIG. 12 are diagrams illustrating examples of extraction of display candidate advertisements according to a modification. In the examples illustrated in FIG. 11 and FIG. 12, the distribution apparatus 100 extracts, as the display candidate advertisements, three advertisements from the advertisement information.

FIG. 11 illustrates an example in which advertisements for applications that are not installed in the terminal device 10 are extracted as the display candidate advertisements from the advertisement information. Advertisement information AL20 illustrated in FIG. 11 is, for example, advertisement information stored in the advertisement information storage unit 121, and indicates only information on items needed for explanation. Specifically, the advertisement information AL20 indicates the order, the advertisement ID, and the application name in the advertisement information. The advertisement information AL20 in FIG. 11 contains the advertisement for the application A with the first priority, the advertisement for the application B with the second priority, the advertisement for the application C with the third priority, the advertisement for the application D with the fourth priority, the advertisement for the application E with the fifth priority, the advertisement for the application F with the sixth priority, and the like.

Furthermore, user application information DL20 illustrated in FIG. 11 is user application information on a user U3, and indicates only information on items needed for explanation. Specifically, the user application information DL20 indicates the user ID and the application name in the user application information. The user application information DL20 in FIG. 11 indicates that the application A, the application C, the application F, and the application I are already installed in the terminal device 10 of the user U3.

Incidentally, the distribution apparatus 100 extracts, from the advertisement information AL20, display candidate advertisements CL20 except for the applications contained in the user application information DL20. In the example illustrated in FIG. 11, the user application information DL20 contains the application A and the application C among the applications A, B, and C corresponding to the three advertisements with the first to the third priorities in the advertisement information AL20. Therefore, in FIG. 11, the advertisement for the application B is extracted as the display candidate advertisement CL20, but the advertisement for the application A and the advertisement for the application C are not extracted as the display candidate advertisements CL20. Then, the distribution apparatus 100 extracts two other advertisements as the display candidate advertisements CL20 from among advertisements with the fourth and lower priorities. The distribution apparatus 100 extracts, as the display candidate advertisement CL20, an advertisement for an application that is not contained in the user application information DL20 and that has the highest priority from among the advertisements with the forth and lower priorities. In FIG. 11, the distribution apparatus 100 extracts, as the display candidate advertisement CL20, the advertisement for the application D that has the fourth priority and that is not contained in the user application information DL20, and extracts the advertisement for the application E that has the fifth priority and that is not contained in the user application information DL20. Therefore, the distribution apparatus 100 extracts the display candidate advertisements CL20 such that the advertisement for the application B is the first priority, the advertisement for the application D is the second priority, and the advertisement for the application E is the third priority. Incidentally, the terminal device 10 that has received the display candidate advertisements CL20 from the distribution apparatus 100 selects, as the display target advertisement, an advertisement that is for a non-installed application and that has a higher priority from among the display candidate advertisements CL20. For example, if the application B is an application that is not installed in the terminal device 10 that has received the display candidate advertisements CL20, the advertisement for the application B is selected as the display target advertisement.

FIG. 12 illustrates an example in which advertisements for applications installed in the terminal device 10 are extracted as the display candidate advertisements from the advertisement information. The advertisement information AL20 and the user application information DL20 illustrated in FIG. 12 are the same as the advertisement information AL20 and the user application information DL20 illustrated in FIG. 11.

In the example illustrated in FIG. 12, the distribution apparatus 100 extracts, as a display candidate advertisement CL21, an advertisement for an application contained in the user application information DL20 from the advertisement information AL20. In the example illustrated, in FIG. 12, the user application information DL20 contains the application A and the application C among the applications A, B, and C corresponding to the three advertisements with the first to the third priorities in the advertisement information AL20. Therefore, in FIG. 12, the advertisement for the application A and the advertisement for the application C are extracted as the display candidate advertisements CL21, but the advertisement for the application B is not extracted as the display candidate advertisement CL21. Then, the distribution apparatus 100 extracts one other advertisement as the display candidate advertisement CL21 from among advertisements with the fourth and lower priorities. The distribution apparatus 100 extracts, as the display candidate advertisement CL21, an advertisement for an application that is contained in the user application information DL20 and that has the highest priority from among the advertisements with the fourth and lower priorities. In FIG. 12, the user application information DL20 does not contain the advertisement for the application D with the fourth priority and the advertisement for the application E with the fifth priority; therefore, these advertisements are not extracted as the display candidate advertisements CL21. Therefore, the distribution apparatus 100 extracts, as the display candidate advertisement CL21, the advertisement for the application F that has the sixth priority and that is contained in the user application information DL20. Consequently, the distribution apparatus 100 extracts the display candidate advertisements CL21 such that the advertisement for the application A is the first priority, the advertisement for the application C is the second priority, and the advertisement for the application F is the third priority. Incidentally, the terminal device 10 that has received the display candidate advertisements CL21 from the distribution apparatus 100 selects, as the display target advertisement, an advertisement with a higher priority from among the display candidate advertisements CL21 for example. For example, the terminal device 10 that has received the display candidate advertisements CL21 selects, as the display target advertisement, the advertisement for the application A.

In the above-described examples, when advertisements for non-installed applications are extracted from the advertisement information AL20, the advertisements for the applications B, D, and E are extracted as the display candidate advertisements CL20, and, when advertisements for installed applications are extracted, the advertisements for the applications A, C, and F, are extracted as the display candidate advertisements CL21. Therefore, the distribution apparatus 100 can improve the advertising effect by extracting the display candidate advertisements by appropriately changing between distribution of advertisements for non-installed applications and distribution of advertisements for installed application depending on the purpose or the timing. Furthermore, during a campaign or the like for a specific application, the distribution apparatus 100 may distribute an advertisement for the specific application to the terminal device 10 of a user who has already installed the specific application. Accordingly, the distribution apparatus 100 can further improve the advertising effect as compared to a case where the advertisement for the specific application is distributed regardless of installation or non-installation of the specific application. Furthermore, the terminal device 10 that has received the advertisements for the installed applications as the display candidate advertisements from the distribution apparatus 100 may select, as the display target advertisement, an advertisement for an application that is not activated for a predetermined period (for example, one month) or longer from among the display candidate advertisements. Therefore, the terminal device 10 can motivate a user who has installed the application but has not used the application for a long time to use the application, so that it is possible to improve the advertising effect.

5-2. Distribution of Advertisement According to Category of Application

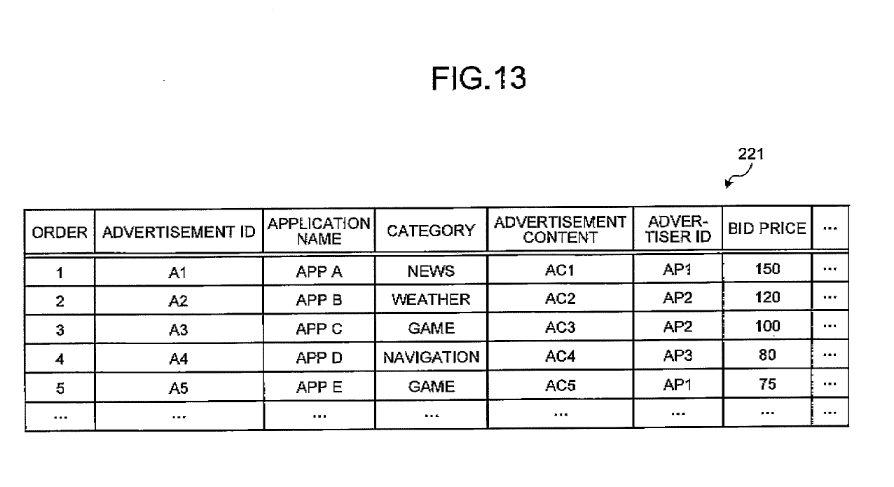

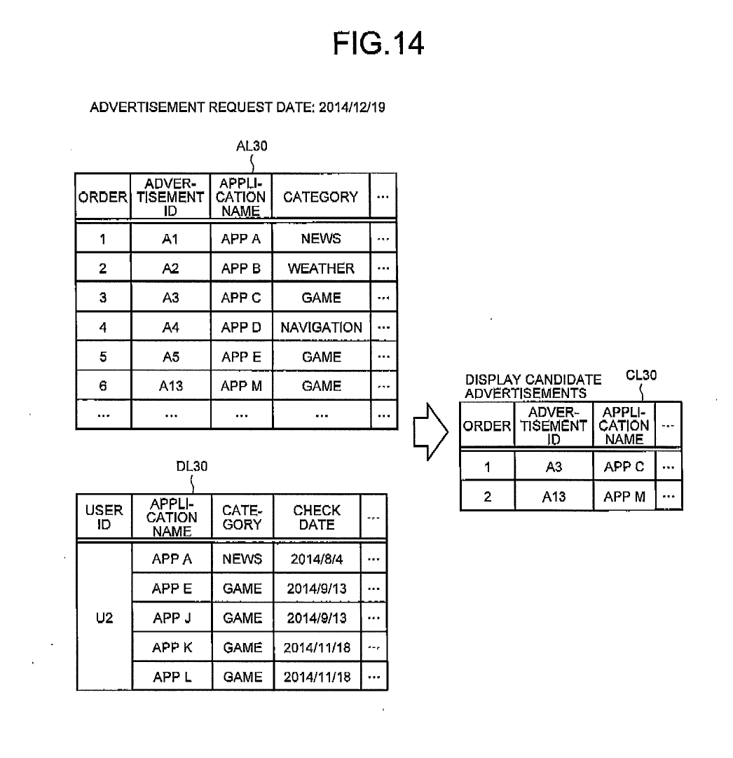

The distribution apparatus 100 may distribute advertisements according to a category of an application installed in the terminal device 10. This will be described below with reference to FIG. 13 and FIG. 14. FIG. 13 is a diagram illustrating an example of an advertisement information storage unit 221 according to a modification.

The advertisement information storage unit 221 illustrated in FIG. 13 contains items of “order”, “advertisement ID”, “application name”, “category”, “advertisement content”, “advertiser ID”, and “bid price”. The “order”, the “advertisement ID”, the “application name”, the “advertisement content”, the “advertiser ID”, and the “bid price” in the advertisement information storage unit 221 are the same as those in the advertisement information storage unit 121 illustrated in FIG. 3. The “category” indicates a category into which each application is classified according to a content of the application, similarly to the “category” in the user application information storage unit 122 in FIG. 4. In the example illustrated in FIG. 13, the application A is classified into a category of “news”, and the application A is classified into a category of “weather”.

FIG. 14 is a diagram illustrating an example of extraction of display candidate advertisements according to the modification. In the example illustrated in FIG. 14, the distribution apparatus 100 extracts two advertisements as the display candidate advertisements from the advertisement information.

FIG. 14 illustrates an example in which advertisements for applications highly expected to be installed by the user of the terminal device 10 are extracted as the display candidate advertisements from the advertisement information at a predetermined timing, on the basis of the user application information. Advertisement information AL30 illustrated in FIG. 14 is, for example, advertisement information stored in the advertisement information storage unit 221, and indicates only information on items needed for explanation. Specifically, the advertisement information AL30 indicates the order, the advertisement ID, the application name, and the category in the advertisement information. The advertisement information AL30 in FIG. 14 contains the advertisement for the application A with the first priority, the advertisement for the application B, with the second priority, the advertisement for the application C with the third priority, the advertisement for the application D with the fourth priority, the advertisement for the application E with the fifth priority, the advertisement for an application M for the sixth priority, and the like.

Furthermore, user application information DL30 illustrated in FIG. 14 is user application information on the user U2, and indicates only information on items needed for explanation. Specifically, the user application information DL30 indicates the user ID, the application name, the category, and the check date in the user application information. The user application information DL30 in FIG. 14 indicates that the application A, the application E, the application J, the application K, and the application L are installed in the terminal device 10 of the user U2. Furthermore, it is indicated that the application A is an application classified into the category of news, and the applications E, J, K, and L are applications classified into the category of game (hereinafter, referred to as “game applications”).

A case will be described below in which the distribution apparatus 100 accepts an advertisement request from the terminal device 10 of the user U2 on Dec. 19, 2014. First, as illustrated in the user application information DL30 in FIG. 14, four of the five applications installed in the terminal device 10 of the user U2 are game applications. Therefore, it i,s estimated that the user U2 is highly likely to install game applications. Therefore, when accepting an advertisement request from the terminal device 10 of the user U2 after a lapse of a predetermined period from the last check date of a game application in the terminal device 10 of the user U2, the distribution apparatus 100 distributes advertisements for game applications as the display candidate advertisements. In the example illustrated in FIG. 14, the last check date of a game application in the terminal device 10 of the user U2 is the check dates of the application K and the application L, which is Nov. 18, 2014. If a predetermined timing is set to the time after a lapse of one month since the last check date of a game application, the distribution apparatus 100 distributes the advertisements for game applications as the display candidate advertisements to the terminal device 10 of the user U2.

Therefore, the distribution apparatus 100 extracts, as display candidate advertisements CL30, advertisements that are for game applications and that are not contained in the user application information DL30 from the advertisement information AL30. First, in the example illustrated in FIG. 14, the user application information DL30 does not contain the application C that is for a game and that has the third priority in the advertisement information AL30. Therefore, in FIG. 14, the advertisement far the application C is extracted as the display candidate advertisement CL30. Furthermore, the user application information DL30 contains the application E that is for a game and that has the fifth priority in the advertisement information AL30. Therefore, the advertisement for the application E is not extracted as the display candidate advertisement CL30. Moreover, the user application information DL30 does not contain the application M that is for a game and that has the sixth priority in the advertisement information AL30. Therefore, the advertisement for the application M is extracted as the display candidate advertisement CL30. Consequently, the distribution apparatus 100 extracts the display candidate advertisements CL30 such that the advertisement for the application C is the first priority and the advertisement for the application M is the second priority. Then, the distribution apparatus 100 distributes the display candidate advertisements CL30 to the terminal device 10 of the user U2.

Consequently, the distribution apparatus 100 can distribute an advertisement highly expected to be installed by the user of the terminal device 10 at an appropriate timing, so that it is possible to improve the advertising effect. Furthermore, while an example is described in which the predetermined timing is set to the time after a lapse of one month since the last check date of a game application, the timing can be set appropriately depending on the purpose or the like. For example, the timing may be set to the time after a lapse of two month since the last check date or the time after one day since the last check date. Moreover, the distribution apparatus 100 may distribute an advertisement for an application highly expected to be installed by the user of the terminal device 10 that has transmitted the advertisement request, without setting the predetermined timing.

5-3. Distribution of Advertisement Using Attribute Information on User

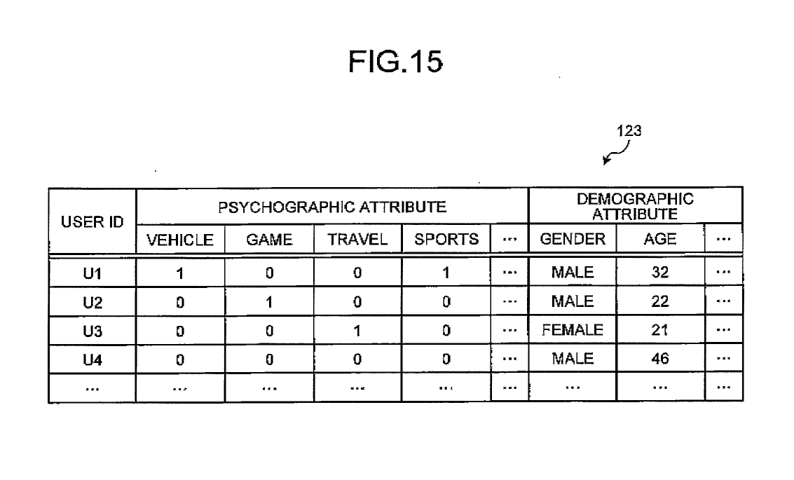

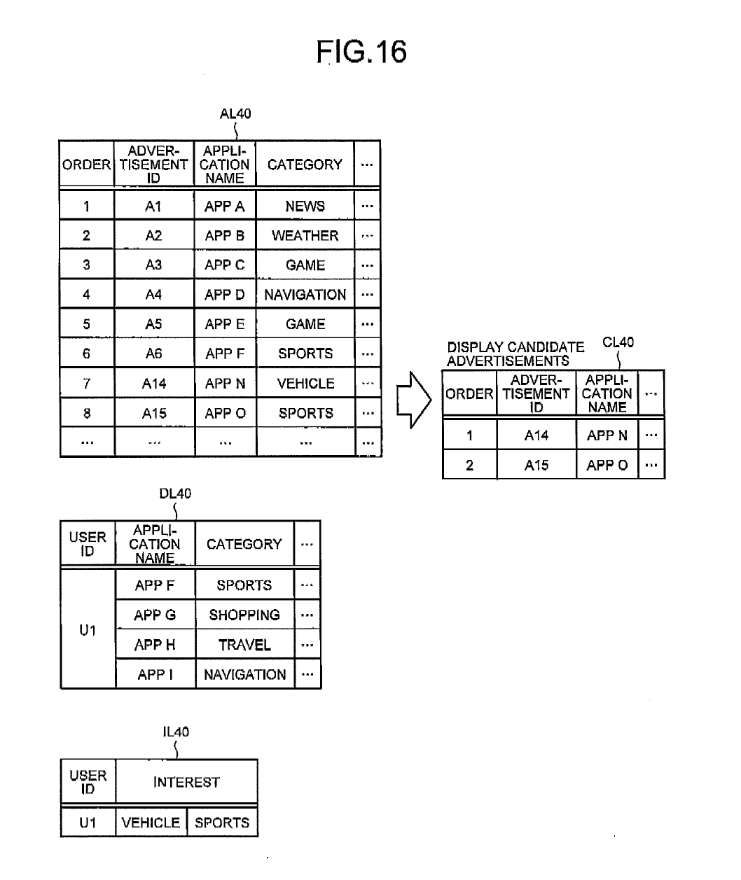

The distribution apparatus 100 may distribute advertisements by using attribute information on the user of the terminal device 10. This will be described below with reference to FIG. 15 and FIG. 16. FIG. 15 is a diagram illustrating an example of an attribute information storage unit 123 according to a modification.

Attribute Information Storage Unit 123

The attribute information storage unit 123 illustrated in FIG. 15 stores therein attribute information on a user. For example, the attribute information storage unit 123 stores therein, as the attribute information on the user, a psychographic attribute or a demographic attribute of the user.

FIG. 15 illustrates an example of the attribute information on the user stored in the attribute information storage unit 123. As illustrated in FIG. 15, the attribute information on the user stored in the attribute information storage unit 123 includes items of “user ID”, “psychographic attribute”, “demographic attribute”, and the like. The “user ID” indicates identification information for identifying the user. The “psychographic attribute” indicates value, lifestyle, characters, preference, and the like of the user. The “demographic attribute” indicates demographic information on the user.

In the example illustrated in FIG. 15, the attribute information storage unit 123 stores therein, as the “psychographic attribute”, information on an object in which the user is interested. Specifically, the attribute information storage unit 123 stores therein, as the “psychographic attribute”, interests in “vehicle”, “game”, “travel”, “sports”, for each user. Each of the items of the “psychographic attribute” corresponds to the “category” in the user application information storage unit 122 and the advertisement information storage unit 221. Specifically, categories of applications include categories corresponding to “vehicle”, “game”, “travel”, and “sports” in the attribute information storage unit 123. Furthermore, the attribute information storage unit 123 may store “1” for an object in which the user is highly interested, and “0” for an object in which the user is less interested. In the example illustrated in FIG. 15, it is indicated that the user U1 is highly interested in a vehicle and sports, but is less interested in a game and a travel. The attribute information storage unit 123 may store therein, as the “psychographic attribute”, any type of information, such as information on lifestyle of the user, related to the psychographic attribute.

In the example illustrated in FIG. 15, the attribute information storage unit 123 stores therein, as the “demographic attribute”, “gender”, and “age” of the user. For example, the gender of male and the age of 32 years old are stored for the user U1. The attribute information storage unit 123 may store, as the “demographic attribute”, any type of information on the demographic attribute, such as occupation, family. structure, annual income, hometown, or academic qualifications of the user. Incidentally, the information stored in the attribute information storage unit 123 as described above may be acquired when the information on the installation of the applications corresponding to the distributed display candidate advertisements are accepted from the terminal device 10 of the user who has logged in a predetermined service, or may be acquired from the user, for example. Furthermore, when the distribution apparatus 100 can acquire the attribute information on the user of the terminal device 10 that has transmitted the advertisement request from an external information processing apparatus or the like, the attribute information storage unit 123 may not be provided. Moreover, the distribution apparatus 100 may estimate information on the psychographic attribute, such as an object in which the user is highly interested, from the information on the demographic attribute.

FIG. 16 is a diagram illustrating an example of extraction of display candidate advertisements according to the modification. In the example illustrated in FIG. 16, the distribution apparatus 100 extracts two advertisements as the display candidate advertisements from the advertisement information.

FIG. 16 illustrates an example in which the display candidate advertisements are extracted from the advertisement information by using the attribute information on the user of the terminal device 10. Advertisement information AL40 illustrated in FIG. 16 is, for example, advertisement information stored in the advertisement information storage unit 221, and indicates only information on items needed for explanation. Specifically, the advertisement information AL40 indicates the order, the advertisement ID, the application name, and the category in the advertisement information. The advertisement information AL40 illustrated in FIG. 16 contains the advertisement for the application A with the first priority, the advertisement for the application B with the second priority, the advertisement for the application C with the third priority, the advertisement for the application D with the fourth priority, and the like.

Furthermore, user application information DL40 illustrated in FIG. 16 is user application information on the user U1, and indicates only information on items needed for explanation. Specifically, the user application information DL40 indicates the user ID, the application name, and the category in the user application information. The user application information DL40 in FIG. 16 indicates that the application F, the application G, the application and the application I are already installed in the terminal device 10 of the user U1. Furthermore, interest information IL40 illustrated in FIG. 16 is information on an object in which the user is highly interested based on the information on the psychographic attribute stored in the attribute information storage unit 123, and indicates only information on the user U1 needed for explanation. The interest information IL40 illustrated in FIG. 16 indicates that the user U1 is highly interested in a vehicle and sports.

The distribution apparatus 100 extracts, as the display candidate advertisement CL40, an advertisement for an application in which the user U1 is highly interested and which is not contained in the user application information DL40, from the advertisement information AL40. In the example illustrated in FIG. 14, the categories of the applications A, B, C, D, and E corresponding to the five advertisements with the first to the fifth priorities in the advertisement information AL40 do not correspond to the interested objects in the interest information IL40. The categories of the applications A, B, C, D, and E are not a vehicle or sports in which the user U1 is highly interested. Therefore, in FIG. 16, the advertisements for the applications A, B, C, D, and E are not extracted as the display candidate advertisements CL40. Accordingly, the distribution apparatus 100 extracts two advertisements as the display candidate advertisements CL40 from among advertisements with the sixth and lower priorities. The distribution apparatus 100 extracts, as the display candidate advertisements CL40, advertisements that are for applications corresponding to the objects in which the user U1 is highly interested and that are not contained in the user application information DL40, from among the advertisements with the sixth and lower priorities. The application F for the advertisement with the sixth priority is classified into the category of sports and is therefore corresponds to the object in which the user U1 is highly interested. However, the application F is contained in the user application information DL40 and is therefore not extracted. Accordingly, the distribution apparatus 100 extracts, as the display candidate advertisement CL40, an advertisement for an application N that is an application for a vehicle corresponding to the object in which the user U1 is highly interested and that is not contained in the user application information DL40. Furthermore, the distribution apparatus 100 extracts, as the display candidate advertisement CL40, an advertisement for an application O that is an application for sports corresponding to the object in which the user U1 is highly interested and that is not contained in the user application information DL40. Therefore, the distribution apparatus 100 extracts the display candidate advertisements CL40 such that the advertisement for the application N is the first priority and the advertisement for the application O is the second priority.

Consequently, the distribution apparatus 100 can distribute an advertisement for an application in which the user of the terminal device 10 is highly interested and which is not installed, so that it is possible to improve the advertising effect. The distribution apparatus 100 may distribute an advertisement by using information that is appropriately extracted according to purposes from the attribute information on the user, in addition to the example as described above. For example, the distribution apparatus 100 may distribute an advertisement based on information on the demographic attribute. Specifically, if there is an application expected to be installed by twenty-something female users, the distribution apparatus 100 may distribute an advertisement for the application with a higher priority to a terminal device of a twenty-something female user. Therefore, the distribution apparatus 100 can appropriately distribute an advertisement according to the attribute, and can improve the advertising effect.

Furthermore, the accepting unit 131 may accept information on operation of an application from the terminal device 10. For example, the accepting unit 131 may accept, as the information on the operation of an application, an operation history of an application in the terminal device 10. The operation history includes, for example, operation status of the application for a few days before acceptance, the number of activations of the application, the activation duration of the application, request information (a search query, distribution news, or the like) from the application. For example, the accepting unit 131 accepts information on operation of an application from the terminal device 10 in which the application managed by the distribution apparatus 100 is installed. Furthermore, the accepting unit 131 may accept information on operation of an application from the terminal device 10 in which the application generated by using a predetermined software development kit (SDK) is installed.

The extracting unit 132 may estimate the interest of the user of the terminal device 10 through estimation based on the information on the operation of an application accepted by the accepting unit 131. For example, if the number of activations or the activation duration of a game application is greater than those of applications of other categories in information on operation of applications accepted from the terminal device 10, the extracting unit 132 may estimate that the user of the terminal device 10 is highly interested in games for distribution of advertisements. For example, the extracting unit 132 may store information indicating a high interest, in the item of a game of the psychographic attribute of the user of the terminal device 10 in the attribute information storage unit 123.

5-4. Distribution of Advertisements for Objects Other Than Applications

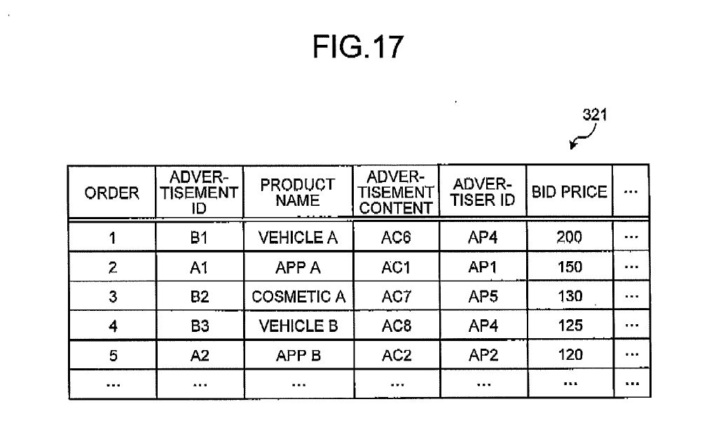

The distribution apparatus 100 may distribute not only advertisements for applications but also advertisements for objects other than the applications. This will be described below with reference to FIG. 17 and FIG. 10. FIG. 17 is a diagram illustrating an example of an advertisement information storage unit 321 according to a modification.

The advertisement information storage unit 321 illustrated in FIG. 17 contains items of “order”, “advertisement ID”, “product name”, “advertisement content”, “advertiser ID”, and “bid price”, similarly to the advertisement information storage unit 121 illustrated in FIG. 3. The advertisement information stored in the advertisement information storage unit 321 illustrated in FIG. 17 contains advertisements for objects other than applications. Specifically, in the example illustrated in FIG. 17, the advertisement information in the advertisement information storage unit 321 contains advertisements for products other than applications, which are an advertisement with the first priority, an advertisement with the third priority, and an advertisement with the fourth priority. In FIG. 17, the advertisement with the first priority and the advertisement with the fourth priority are advertisements for vehicles, and the advertisement with the third priority is an advertisement for a cosmetic. Specifically, the advertisement with the first priority is an advertisement for a vehicle A, the advertisement with the third priority is an advertisement for a cosmetic A, and the advertisement with the fourth priority is an advertisement for a vehicle B.

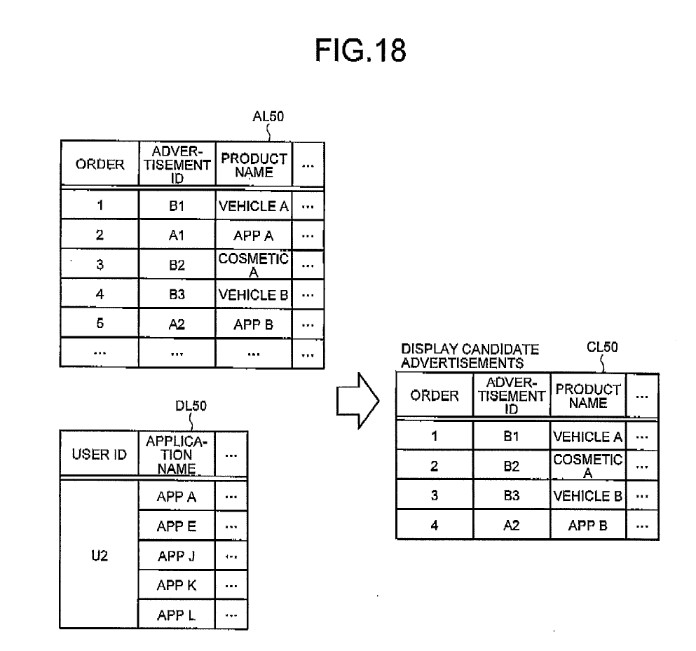

FIG. 18 is a diagram illustrating an example of extraction of display candidate advertisements according to the modification. In the example illustrated in FIG. 18, the distribution apparatus 100 extracts four advertisements as the display candidate advertisements from the advertisement information.

FIG. 18 illustrates an example in which advertisements for applications that are not installed in the terminal device 10 and advertisements for objects other than applications are extracted as the display candidate advertisements from the advertisement information. Advertisement information AL50 illustrated in FIG. 18 is, for example, advertisement information stored in the advertisement information storage unit 321, and indicates only information on items needed for explanation. Specifically, the advertisement information AL50 indicates the order, the advertisement ID, and the product name in the advertisement information. The advertisement information AL50 illustrated in FIG. 18 contains the advertisement for the vehicle A with the first priority, the advertisement for the application A with the second priority, the advertisement for the cosmetic A with the third priority, the advertisement for the vehicle B with the fourth priority, the advertisement for the application B with the fifth priority, and the like.

Furthermore, the user application information DL50 illustrated in FIG. 18 is the user application information on the user U2, and indicates only information on items needed for explanation. Specifically, the user application information DL50 indicates the user ID and the application name in the user application information. The user application information DL50 illustrated in FIG. 18 indicates that the application A, the application E, the application J, the application K, and the application L are already installed in the terminal device 10 of the user U2.

The distribution apparatus 100 extracts the display candidate advertisements CL50 from the advertisement information AL50 except for the applications contained in the user application information DL50. In the example illustrated in FIG. 18, the user application information DL50 contains the application A among the vehicle A, the application A, the cosmetic A, and the vehicle B corresponding to the four advertisements with the first to the fourth priorities in the advertisement information AL50. Therefore, in FIG. 18, the advertisement for the application A is not extracted as the display candidate advertisement CL50. Then, the distribution apparatus 100 extracts one other advertisement as the display candidate advertisement CL50 from among advertisements with the fifth and lower priorities. The distribution apparatus 100 extracts, as the display candidate advertisement CL50, an advertisement, which is for a target that is not contained in the user application information DL50 and which has the highest priority, from among the advertisements with the fifth and lower priorities. In FIG. 18, the distribution apparatus 100 extracts, as the display candidate advertisement CL50, the advertisement for the application B that has the fifth priority and that is not contained in the user application information DL50. Therefore, the distribution apparatus 100 extracts the display candidate advertisement CL50 such that the advertisement for the vehicle A is the first priority, the advertisement for the cosmetic item A is the second priority, the advertisement for the vehicle B is the third priority, and the advertisement for the application B is the fourth priority.

Consequently, even when the advertisement information contains advertisements for objects other than applications, the distribution apparatus 100 can distribute advertisements. Furthermore, if the advertisement information contains advertisements for objects other than applications, the distribution apparatus 100 may distribute a display target advertisement in which the user of the terminal device 10 is expected to be highly interested. Therefore, even when the advertisement information contains advertisements for objects other than applications, the distribution apparatus 100 extracts advertisements based on the interest of the user, so that it is possible extract advertisements for applications and, advertisements for others on the same basis. Therefore, the distribution apparatus 100 can distribute advertisements more suitable for the user of the terminal device 10, and can improve the advertising effect. Incidentally, when the distribution apparatus 100 extracts advertisements based on the interest of the user, the advertisement information may be only advertisements for objects other than applications. Furthermore, when the distribution apparatus 100 distributes advertisements according to the categories of applications installed in the terminal device 10, the advertisement information may be only advertisements for objects other than applications.

5-5. Charging

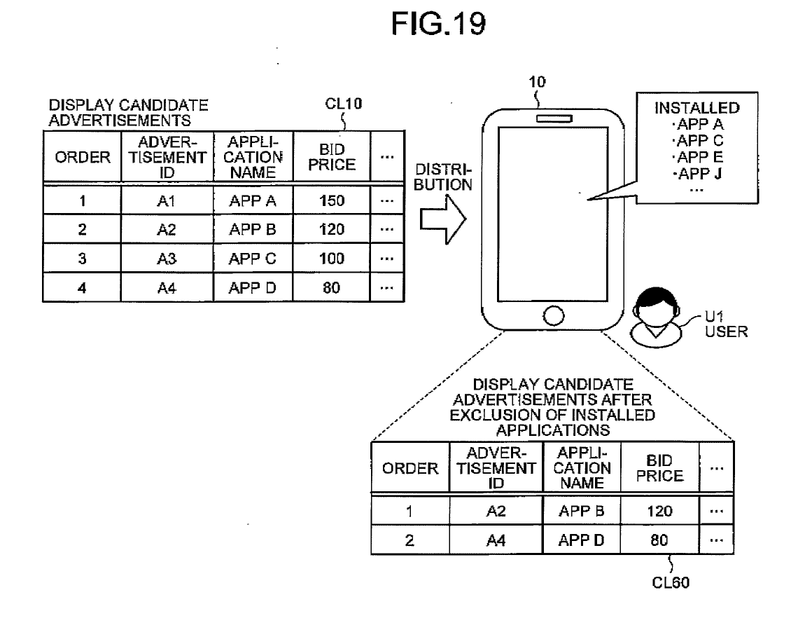

In the distribution system 1 according to the above-described embodiment, the order of the display candidate advertisements distributed to the terminal device 10 may be changed. Therefore, the distribution system 1 may charge a fee to an advertiser who is a provider of an advertisement based on the display candidate advertisements after the selection process performed by the terminal device 10. Specifically, the distribution system 1 may charge a fee to an advertiser as a provider of an advertisement based on the display candidate advertisement after applications installed in the terminal device 10 are excluded. In this case, the distribution system 1 may include a calculation device that, calculates a fee charged to the advertiser. In this case, the transmitting unit 155 of the terminal device 10 transmits, to the calculation device, information on the display candidate advertisements after exclusion of the installed application. Then, the calculation device that has received the information from the terminal device 10 may calculate a fee charged to the advertiser. This will be described below with reference to FIG. 19. The example illustrated in FIG. 19 is the same as the example illustrated in FIG. 1.

FIG. 19 is a diagram illustrating an example of the selection process performed by the terminal device 10 according to a modification. The display candidate advertisements CL10 illustrated in FIG. 19 are the same as the display candidate advertisements CL10 illustrated in FIG. 5 and are display candidate advertisements including the advertisement for the application A with the first priority, the advertisement for the application B with the second priority, the advertisement for the application C with the third priority, and the advertisement for the application D with the fourth priority.

The distribution apparatus 100 distributes the display candidate advertisements CL10 to the, terminal device 10 (corresponding to Step S14 in FIG. 1). The terminal device 10 that has received the display candidate advertisements CL10 from the distribution apparatus 100 performs the selection process (corresponding to Step S15 in FIG. 1). Specifically, the terminal device 10 excludes, from the display candidate advertisements CL10, the advertisement for the application A and the advertisement for the application C that are applications installed in the terminal device 10. Therefore, the advertisement for the application B that is the non-installed application and the advertisement for the application D that is the non-installed application remain as display candidate advertisements CL60 after exclusion of the installed applications as illustrated in FIG. 19. Then, the terminal device 10 displays the advertisement for the application B with the higher order (corresponding to Step S16 in FIG. 1).

For example, the terminal device 10 may transmit information on the display candidate advertisements CL60 after exclusion as illustrated in FIG. 19 to the calculation device. Specifically, the transmitting unit 155 of the terminal device 10 may transmit, to the calculation device, information indicating that the advertisement for the application B is displayed, information on the bid price for the advertisement for the application B, and information on the bid price for the advertisement for the application D with the second priority.

The calculation device that has received information on the display candidate advertisement CL60 after exclusion from the terminal device 10 may calculate a fee charged to an advertiser of the advertisement for the application B based on the received information. For example, when calculating a fee that is charged to the advertiser through a so-called second price auction, the calculation device calculates the fee charged to the advertiser of the advertisement for the application B based on the information on the bid price for the advertisement for the application D with the second priority from among pieces of the received information. For example, when the calculation device charges a bid price with the second priority to an advertiser of a displayed advertisement, the advertiser of the advertisement for the application B is charged for the bid price of 80 (for example, 80 yen) corresponding to the advertisement for the application D with the second priority. As described above, it is possible to more appropriately calculate the fee charged to the advertiser. The calculation device may be the distribution apparatus 100 or a different device.

5-6. Others

In the above-described embodiment, an example has been described in which an advertisement is displayed on an application screen of an application activated in the terminal device 10. However, for example, it may be possible to display an advertisement when the terminal device 10 views a web page by a browser or the like. Furthermore, when the terminal device 10 displays an advertisement for an application regardless of whether the application is installed or not, it may be possible to change the process to be performed after the displayed advertisement is specified. For example, when the displayed advertisement is an advertisement for an application that is not installed in the terminal device 10 and when the user specifies the advertisement, the terminal device 10 may perform a process related to installation of the application that is not installed. For example, the terminal device 10 may display, on the terminal, a screen for confirming execution of installation of a non-installed application, or may perform a process of downloading the non-installed application. Furthermore, for example, when the displayed advertisement is an advertisement for an application installed in the terminal device 10 and when the user specifies the advertisement, the terminal device 10 may perform a process of activating the installed application. Therefore, the terminal device 10 can receive distribution of advertisements even from the distribution apparatus 100 that does not recognize the installation status of applications in the terminal device 10, and, by changing the process after display of the advertisement depending on the installation or non-installation of the application, it is possible to improve the advertising effect.

Furthermore, when displaying an advertisement on an application screen of an application activated in the terminal device 10, the distribution apparatus 100 may not extract the advertisement for the activated application as the display candidate advertisement. Consequently, the distribution apparatus 100 can prevent distribution of the advertisement for the application used by the user, that is, the installed application, so that it is possible to improve the advertising effect. Moreover, even when the distributed display candidate advertisements include the advertisement for the activated application, the terminal device 10 may not employ the advertisement for the activated application as the display target advertisement.

6. Advantageous Effects

As described, above, the distribution apparatus 100 according to the embodiment includes the accepting unit 131 and the distributing unit 133. The accepting unit 131 accepts an advertisement request from an application that operates an the terminal device 10. The distributing unit 133, when the accepting unit 131 accepts the advertisement request, distributes a plurality of display candidate advertisements, which are advertisements as candidates to be displayed, to the terminal device 10 that selects a display target advertisement based on information on installed applications from along the display candidate advertisements.

Therefore, the distribution apparatus 100 according to the embodiment can improve the advertising effect by distributing a plurality of advertisements as the display candidate advertisements to the terminal device 10. Furthermore, the distribution system 1 can display an appropriate advertisement on the terminal device 10 depending on the installation status of applications in the terminal device 10 at the time of distribution, so that it is possible to improve the advertising effect.

Furthermore, in the distribution apparatus 100 according to the embodiment, the distributing unit 133 distributes the display candidate advertisements to the terminal device 10 that, selects, as the display target advertisement, an advertisement for a non-installed application from among the display candidate advertisements.

Therefore, even when the installation status of the applications in the terminal device 10 is not recognized, the distribution apparatus 100 according to the embodiment can improve the advertising effect by distributing a plurality of advertisements to the terminal device 10 that selects an advertisement for a non-installed application as the display target advertisement.

Moreover, in the distribution apparatus 100 according to the embodiment, the distributing unit 133 distributes the display candidate advertisements to the terminal device 10 that selects, as the display target advertisement, an advertisement for an installed application from among the display candidate advertisements.

Therefore, the distribution apparatus 100 according to the embodiment can motivate a user who has installed an application but has not used the application for a long time to use the application. Consequently, it is possible to improve the advertising effect. Furthermore, during a campaign or the like for a specific application, the distribution apparatus 100 distributes an advertisement for a specific application to the terminal device 10 of a user who has already installed the specific application. Therefore, it is possible to further improve the advertising effect as compared to a case where the advertisement for the application is installed regardless of installation or non-installation of applications.

Furthermore, the distribution apparatus 100 according to the embodiment includes the extracting unit 132. The extracting unit 132 extracts display candidate advertisements from a predetermined advertisement group (“the advertisement information” in the embodiment, and the same applies to the following). Moreover, the accepting unit 131 accepts information on applications corresponding to the distributed display candidate advertisements from the terminal device 10 to which the display candidate advertisements are distributed. Furthermore, when the accepting unit 131 accepts an advertisement request, the extracting unit 132 extracts the display candidate advertisements from the predetermined advertisement group based on information on applications. The distributing unit 133 distributes the display candidate advertisements extracted by the extracting unit 132 to the terminal device 10.

Therefore, the distribution apparatus 100 according to the embodiment updates the user application information based on installation and non-installation of applications corresponding to the distributed display candidate advertisements accepted from the terminal device 10, and extracts the display candidate advertisements more suitable for the user of the terminal device 10. Consequently, the distribution apparatus 100 can distribute advertisements more suitable for the user of the terminal device 10, so that it is possible to further improve the advertising effect. Furthermore, the distribution apparatus 100 receives only information on installation of applications corresponding to the distributed display candidate advertisements from the terminal device 10, so that it is possible to reduce psychological resistance of the user of the terminal device 10, improve the advertising effect, and promote use of the advertisement distribution by the distribution apparatus 100.

Moreover, in the distribution apparatus 100 according to the embodiment, the distributing unit 133 accepts, as the information on the applications, information on installation and non-installation of applications corresponding to the distributed display candidate advertisements.

Therefore, the distribution apparatus 100 according to the embodiment updates the user application information based on installation and non-installation of the applications corresponding to the distributed display candidate advertisements accepted from the terminal device 10, and extracts the display candidate advertisements more suitable for the user of the terminal device 10. Consequently, the distribution apparatus 100 can distribute advertisements more suitable for the user of the terminal device 10, so that it is possible to improve the advertising effect. Furthermore, the distribution apparatus 100 accepts only installation and non-installation of the applications corresponding to the distributed display candidate advertisements from the terminal device 10, so that it is possible to reduce the psychological resistance of the user of the terminal device 10, improve the advertising effect, and promote use of the advertisement distribution by the distribution apparatus 100.

Furthermore, in the distribution apparatus 100 according to the embodiment, the extracting unit 132 extracts the display candidate advertisements from the predetermined advertisement group based on information on the interest of the user of the terminal device 10.

Therefore, the distribution apparatus 100 according to the embodiment can distribute advertisements for applications in which the user of the terminal device 10 is highly interested, so that it is possible to improve the advertising effect. For example, if there is an application expected to be installed by twenty-something female users, the distribution apparatus 100 may distribute an advertisement for the application with a higher priority to a terminal device of a twenty-something female user. Therefore, the distribution apparatus 100 can appropriately distribute an advertisement according to the attribute, and can improve the advertising effect.

Moreover, in the distribution apparatus 100 according to the embodiment, the accepting unit 131 accepts information on operation of an application from the terminal device 10. Furthermore, the extracting unit 132 estimates the interest of the user of the terminal device 10, where the estimation is performed based on the information on operation of the application accepted by the accepting unit 131.

Therefore, the distribution apparatus 100 according to the embodiment can estimate the interest of the user based on the operation status of the applications of the user of the terminal device 10, so that it is possible to distribute more appropriate advertisements for applications corresponding to the interest of the user, and improve the advertising effect. Consequently, the distribution apparatus 100 can appropriately distribute advertisements according to the attribute, and improve the advertising effect.

Furthermore, in the distribution apparatus 100 according to the embodiment, the distributing unit 133 distributes display candidate advertisements, to which priorities are assigned, to the terminal device 10 that selects the display target advertisement based on the priorities assigned to the display candidate advertisements.

Therefore, the distribution apparatus 100 according to the embodiment distributes a plurality of advertisements to the terminal device 10 that selects an advertisement with a higher priority, so that it is possible to distribute appropriate advertisements and improve the advertising effect.

Moreover, in the distribution apparatus 100 according to the embodiment, the distributing unit 133 distributes, as the display candidate advertisements, a plurality of advertisements except for an advertisement for the application that is a transmission source of the advertisement request.

Therefore, the distribution apparatus 100 according to the embodiment can prevent distribution of the advertisement for the application used by the user, that is, the installed application, so that it is possible to improve the advertising effect.

Furthermore, in the distribution apparatus 100 according to the embodiment, the accepting unit 131 accepts an advertisement request from the terminal device 10. Moreover, when the accepting unit 131 accepts the advertisement request, the extracting unit 132 extracts advertisements from the predetermined advertisement group based on the information on the applications installed in the terminal device 10. The distributing unit 133 distributes the advertisements extracted by the extracting unit 132 to the terminal device 10.

Therefore, the distribution apparatus 100 according to the embodiment extracts the advertisements based on the information on the applications installed in the terminal device 10. Consequently, the distribution apparatus 100 can distribute the advertisements more suitable for the user of the terminal device 10, so that it is possible to improve the advertising effect.

Moreover, in the distribution apparatus 100 according to the embodiment, the extracting unit 132 extracts advertisements for applications that are not installed in the terminal device 10.

Therefore, the distribution apparatus 100 according to the embodiment extracts advertisements including the advertisements for the non-installed applications and transmit the advertisements to the terminal device 10 so as to improve the probability that the non-installed applications are installed in the terminal device 10. Therefore, the distribution apparatus 100 can improve the advertising effect.

Furthermore, in the distribution apparatus 100 according to the embodiment, the accepting unit 131 accepts, as the advertisement request, an advertisement request from an application that operates on the terminal device 10, and accepts the information on the applications corresponding to the distributed advertisements from the terminal device 10 to which the advertisements are distributed. Moreover, when the accepting unit 131 accepts the advertisement request, the extracting unit 132 extracts the advertisements based on the information on the applications. The distributing unit 133 distributes the advertisements extracted by the extracting unit 132 to the terminal device 10.

Therefore, the distribution, apparatus 100 according to the embodiment updates the user application information based on installation and non-installation of applications corresponding to the distributed advertisements accepted from the terminal device 10, and extracts advertisements more suitable for the user of the terminal device 10. Consequently, the distribution apparatus 100 can distribute the advertisements more suitable for the user of the terminal device 10, so that it is possible to improve the advertising effect. Furthermore, the distribution apparatus 100 accepts only information on installation of the applications corresponding to the distributed advertisements from the terminal device 10, so that it is possible to reduce psychological resistance of the user of the terminal device 10, improve the advertising effect, and promote use of the advertisements distribution by the distribution apparatus 100.

Moreover, in the distribution apparatus 100 according to the embodiment, the accepting unit 131 accepts, as the information on the applications, the information on installation and non-installation of applications corresponding to the distributed advertisements.

Therefore, the distribution apparatus 100 according to the embodiment updates the user application information based on installation and non-installation of the applications corresponding to the distributed advertisements accepted from the terminal device 10, and extracts the advertisements more suitable for the user of the terminal device 10. Consequently, the distribution apparatus 100 can distribute the advertisements more suitable for the user of the terminal device 10, so that it is possible to improve the advertising effect. Furthermore, the distribution apparatus 100 accepts only information on installation and non-installation of the applications corresponding to the distributed advertisements from the terminal device 10, so that it is possible to reduce psychological resistance of the user of the terminal device 10, improve the advertising effect, and promote use of the advertisement distribution by the distribution apparatus 100.

Furthermore, in the distribution apparatus 100 according to the embodiment, the extracting unit 132 extracts a plurality of advertisements as the advertisements. The distributing unit 133 distributes a plurality of advertisements extracted by the extracting unit 132 to the terminal device 10 that selects a display target advertisement from among a plurality, of the advertisements based on the information on the installed applications.

Therefore, the distribution apparatus 100 according to the embodiment extracts a plurality of advertisements more suitable for the user of the terminal device 10 based on installation and non-installation of the applications corresponding to the distributed advertisements accepted from the terminal device 10. Consequently, the distribution apparatus 100 can distribute a plurality of the advertisements more suitable for the user of the terminal device 10, so that it is possible to improve the advertising effect.

The terminal device 10 according to the embodiment includes the receiving unit 152 and the selecting unit 153. The receiving unit 152 receives a plurality of advertisements (“the display candidate advertisements” in the embodiment, and the same applies to the following). Furthermore, the selecting unit 153 selects a display target advertisement from a plurality of the advertisements received by the receiving unit 152 based on the information on the installed applications.

Therefore, the terminal device 10 according to the embodiment receives a plurality of the advertisements as the display candidate advertisements, and displays an appropriate advertisement according to the installation status of the applications in the terminal device 10 at the time of distribution, so that it is possible to improve the advertising effect.

Furthermore, in the terminal device 10 according to the embodiment, the selecting unit 153 selects, as the display target advertisement, an advertisement for a non-installed application from among a plurality of the advertisements.

Therefore, the terminal device 10 according to the embodiment selects and displays the advertisement for the non-installed application as the display target advertisement from among the display candidate advertisements, and increase the possibility that the non-installed application is installed. Consequently, the terminal device 10 can improve the advertising effect.

Moreover, in the terminal device 10 according to the embodiment, the selecting unit 153 selects, as the display target advertisement, an advertisement for an installed application from among a plurality of the advertisements.

Therefore, the terminal device 10 according to the embodiment can motivate a user who has installed the application but has not used the application for a long time, to use the application, so that it is possible to improve the advertising effect. Furthermore, during a campaign or the like for an installed specific application, the terminal device 10 displays an advertisement for the specific application, so that it is possible to further improve the advertising effect as compared to a base where an advertisement for an application is displayed regardless of installation or non-installation of the application.

Furthermore, in the terminal device 10 according to the embodiment, when a user specifies the display target advertisement displayed on the terminal device 10, the selecting unit 153 changes a process to be performed after specification of the display target advertisement, depending on installation or non-installation of an application corresponding to the display target advertisement.

Therefore, the terminal device 10 according to the embodiment can receive distributions of advertisements even from the distribution apparatus 100 that does not recognize the installation status of applications in the terminal device 10, and, by changing the process after display of the advertisement depending on the installation or non-installation of the application, it is possible to improve the advertising effect.

moreover, the terminal device 10 according to the embodiment includes the transmitting unit 155. When the receiving unit 152 receives a plurality of advertisements, the transmitting unit 155 transmits information on applications corresponding to the advertisements received by the receiving unit. 152 to the distribution apparatus 100 that distributes a plurality of advertisements.

Therefore, by sending the information on the applications corresponding to the received advertisements to the distribution apparatus 100 by feedback, the terminal device 10 according to the embodiment can receive distribution of advertisements more suitable for the terminal device 10 from the distribution apparatus 100. Consequently, the terminal device 10 can improve the advertising effect. Furthermore, the terminal device 10 sends only installation and non-installation of the applications corresponding to the distributed advertisements to the distribution apparatus 100 by feedback, so that it is possible to reduce psychological resistance of the user of the terminal device 10, improve the advertising effect, and promote use of the advertisement distribution by the distribution apparatus 100.

7. Hardware Configuration

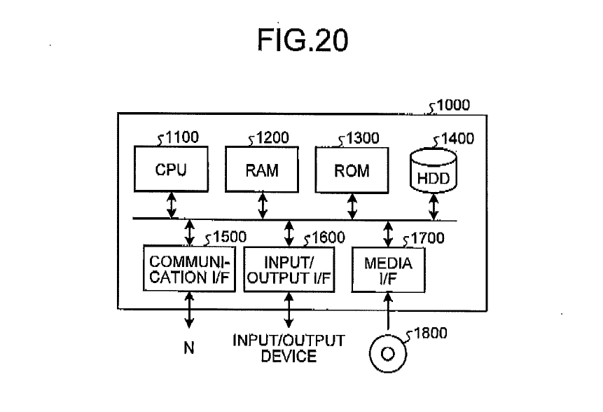

The distribution apparatus 100 according to the embodiment as described above may be implemented by, for example, a computer 1000 with a configuration as illustrated in FIG. 20. FIG. 20 is a diagram illustrating an example of a hardware configuration of the computer 1000 that implements the functions of the distribution apparatus 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates based on a program stored in the ROM 1300 or the HDD 1400, and controls each of units. The ROM 1300 stores therein a boot program executed by the CPU 1100 when the computer 1000 is activated, a program dependent on the hardware of the computer 1000, and the like.

The HDD 1400 stores therein a program executed by the CPU 1100, data used by the program, and the like. The communication interface 1300 receives data from other devices via a network N, sends the data to the CPU 1100, and transmits data generated by the CPU 1100 to other devices via the network N.

The CPU 1100 controls an output device, such as a display or a printer, an input device, such as a keyboard or a mouse, and the like via the input/output interface 1600. The CPU 1100 acquires data from the input device via the input/output interface 1600. The CPU 1100 outputs generated data to the output device via the input/output interface 1600.

The media interface 1700 reads a program or data stored in a recording medium 1600, and provides the program or the data to the CPU 1100 via the RAM 1200. The CPU 1100 loads the program onto the RAM 1200 from the recording medium 1800 via the media interface 1700, and executes the loaded program. The recording medium 1800 may be, for example, an optical recording medium such as a digital versatile disk (DVD) or a phase change rewritable disk (PD), magneto-optical recording medium such as a magneto-optical disk (MO), a tape medium, a magnetic recording medium, or a semiconductor memory.

For example, when the computer 1000 functions as the distribution apparatus 100 according to the embodiment, the CPU 1100 of the computer 1000 executes the program loaded on the RAM 1200, and implements the functions of the control unit 130. While the CPU 1100 of the computer 1000 reads the program from the recording medium 1800 and executes the program, the program may be acquired from other devices via the network N as another embodiment.

While one of the embodiments of the present disclosure has been described in detail with reference to the drawings, the embodiment is merely an example. The disclosed technology may be embodied in various forms including various modifications and improvements based on the knowledge of a person skilled in the art from the aspects in the summary of the invention.

8. Others

Of the processes described in the embodiment, all or part of a process described as being performed automatically may also be performed manually. Alternatively, all or part of a process described as being performed manually may also be performed automatically by known methods. In addition, the processing procedures, specific names, and information including various types of data and parameters illustrated in the above-described document and drawings may be arbitrarily changed unless otherwise specified. For example, various types of information illustrated in the drawings are not limited to those illustrated in the drawings.

The components of apparatuses illustrated in the drawings are functionally conceptual and need not necessarily be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Furthermore, the embodiments may be combined appropriately as long as the processes do not conflict with each other.

Moreover, “a unit” recited in the claims may be replaced with “a section, a module, or a means” or “a circuit”. For example, the accepting unit may be replaced with an accepting means or an accepting circuit.

According to an embodiment of the present invention, it is possible to improve an advertising effect.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth,

What is claimed is:

1. A distribution apparatus comprising:
an accepting unit that accepts an advertisement request from an application that operates on a terminal device; and
a distributing unit that, when the accepting unit accepts the advertisement request, distributes a plurality of display candidate advertisements, which are advertisements as candidates to be displayed, to the terminal device that selects a display target advertisement based on information on installed applications from among the display candidate advertisements.

2. The distribution apparatus according to claim 1, wherein the distributing unit distributes the display candidate advertisements to the terminal device that selects, as the display target advertisement, an advertisement for a non-installed application from among the display candidate advertisements.

3. The distribution apparatus according to claim 1, wherein the distributing unit distributes the display candidate advertisements to the terminal device that selects, as the display target advertisement, an advertisement for an installed application from among the display candidate advertisements.

4. The distribution apparatus according to claim 1, further comprising:
an extracting unit that extracts the display candidate advertisements from a predetermined advertisement group, wherein
the accepting unit accepts information on applications corresponding to the distributed display candidate advertisements from the terminal device to which the display candidate advertisements are distributed,
the extracting unit extracts the display candidate advertisements from the predetermined advertisement group based on the information on the applications when the accepting unit accepts the advertisement request, and
the distributing unit distributes the display candidate advertisements extracted by the extracting unit to the terminal device.

5. The distribution apparatus according to claim 4, wherein the accepting unit accepts, as the information on the applications, information on installation and non-installation of the applications corresponding to the distributed display candidate advertisements.

6. The distribution apparatus according to claim 4, wherein the extracting unit extracts the display candidate advertisements from the predetermined advertisement group based on information on an interest of a user of the terminal device.

7. The distribution apparatus according to claim 6, wherein
the accepting unit accepts information on operation of an application from the terminal device, and
the extracting unit estimates the interest of the user of the terminal device based on the information on the operation of the application accepted by the accepting unit.

8. The distribution apparatus according to claim 1, wherein the distributing unit distributes display candidate advertisements to which priorities are assigned to the terminal device that selects the display target advertisement based on the priorities assigned to the display candidate advertisements.

9. The distribution apparatus according to claim 1, wherein the distributing unit distributes, as the display candidate advertisements, a plurality of advertisements except for an advertisement for the application that is a transmission source of the advertisement request.

10. A distribution method implemented by a computer, comprising:
accepting an advertisement request from an application that operates on a terminal device; and
distributing, when the advertisement request is accepted at the accepting, a plurality of display candidate advertisements, which are advertisements as candidates to be displayed, to the terminal device that selects a display target advertisement based on information on installed applications from among the display candidate advertisements.

11. A non-transitory computer-readable storage medium with an executable program stored thereon, wherein the program instructs a computer to perform:
accepting an advertisement request from an application that operates on a terminal device; and
distributing, when the advertisement request is accepted at the accepting, a plurality of display candidate advertisements, which are advertisements as candidates to be displayed, to the terminal device that selects a display target advertisement based on the information on installed applications from among the display candidate advertisements.

12. A terminal device comprising:
a receiving unit that receives a plurality of advertisements; and
a selecting unit that selects a display target advertisement from among the advertisements received by the receiving unit based on information on installed applications.

13. The terminal device according to claim 12, wherein the selecting unit selects, as the display target advertisement, an advertisement for a non-installed application from the advertisements.

14. The terminal device according to claim 12, wherein the selecting unit selects, as the display target advertisement, an advertisement for an installed application from the advertisements.

15. The terminal device according to claim 12, wherein when a user specifies the display target advertisement displayed on the terminal device, the selecting unit changes a process to be performed after specification of the display target advertisement, depending on installation or non-installation of an application corresponding to the display target advertisement.

16. The terminal device according to claim 12, further comprising a transmitting unit that, when the receiving unit receives the advertisements, transmits information on applications corresponding to the advertisements received by the receiving unit to the distribution apparatus that distributes the advertisements.

17. A selection method implemented by a terminal device, comprising:
receiving a plurality of advertisements; and
selecting a display target advertisement from among the advertisements received at the receiving based on information on installed applications.

18. A non-transitory computer-readable storage medium with an executable program stored thereon, wherein the program instructs a computer to perform:
receiving a plurality of advertisements; and
selecting a display target advertisement from among the advertisements received at the receiving based on information on installed applications.

19. A distribution apparatus comprising:
an accepting unit that accepts an advertisement request from a terminal device;
an extracting unit that, when the accepting unit accepts an advertisement request, extracts an advertisement from a predetermined advertisement group based on information on applications installed in the terminal device; and
a distributing unit that distributes the advertisement extracted by the extracting unit to the terminal device.

20. The distribution apparatus according to claim 19, wherein the extracting unit extracts an advertisement for an application that 15 not installed in the terminal device.

21. The distribution apparatus according to claim 19, wherein
the accepting unit accepts, as the advertisement request, an advertisement request from an application that operates on the terminal device, and accepts information on an application corresponding to the distributed advertisement from the terminal device to which the advertisement is distributed,
the extracting unit extracts an advertisement based on the information on the application when the accepting unit accepts the advertisement request, and
the distributing unit distributes the advertisement extracted by the extracting unit to the terminal device.

22. The distribution apparatus according to claim 21, wherein the accepting unit accepts, as the information on the application, information on installation or non-installation of the application corresponding to the distributed advertisement.

23. The distribution apparatus according to claim 19, wherein
the extracting unit extracts a plurality of advertisements as the advertisement, and
the distributing unit distributes the advertisements extracted by the extracting unit to the terminal device that selects a display target advertisement based on the information on installed applications from among the advertisements.
